(19) United States
(12) Patent Application Publication
(10) Pub. No.: US 2024/0177006 A1
(43) Pub. Date: May 30, 2024

(54) DATA PROCESSING METHOD AND APPARATUS, PROGRAM PRODUCT, COMPUTER DEVICE, AND MEDIUM

(71) Applicant: Tencent Technology (Shenzhen) Company Limited, Shenzhen (CN)

(72) Inventors: Chunxu SHEN, Shenzhen (CN); Kouying Xue, Shenzhen (CN); Hao Cheng, Shenzhen (CN)

(21) Appl. No.: 18/437,118

(22) Filed: Feb. 8, 2024

Related U.S. Application Data
(63) Continuation of application No. PCT/CN2023/084690, filed on Mar. 29, 2023.

(30) Foreign Application Priority Data
May 5, 2022 (CN) 202210479316.8

(51) Int. Cl. G06N 3/082; G06N 3/042

(52) U.S. Cl. CPC G06N 3/082; G06N 3/042

(57) ABSTRACT

This application discloses a data processing method performed by a computer device, and the method includes: obtaining a heterogeneous conversion graph including N object nodes and M resource nodes, when an object has a conversion behavior for a resource, a connecting edge exists between a corresponding object node and a corresponding resource node; obtaining a homogeneous object graph corresponding to each object, the graph including object feature nodes of the corresponding object in a plurality of dimensions; obtaining a homogeneous resource graph corresponding to each resource, the graph including resource feature nodes of the corresponding resource in a plurality of dimensions; and training a prediction network based on the heterogeneous conversion graph, the homogeneous object graph of each object, and the homogeneous resource graph of each resource, to obtain a trained prediction network configured to predict a conversion index of an object of interest for a resource of interest.

### CROSS-REFERENCE TO RELATED APPLICATIONS

This application is a continuation application of PCT Patent Application No. PCT/CN2023/084690, entitled “DATA PROCESSING METHOD AND APPARATUS, PROGRAM PRODUCT, COMPUTER DEVICE, AND MEDIUM” filed on Mar. 29, 2023, which claims priority to Chinese Patent Application No. 202210479316.8, entitled “DATA PROCESSING METHOD AND APPARATUS, PROGRAM PRODUCT, COMPUTER DEVICE, AND MEDIUM” filed with the China National Intellectual Property Administration on May 5, 2022, all of which is incorporated herein by reference in its entirety.

### FIELD OF THE TECHNOLOGY

This application relates to the field of computer technologies, and in particular, a data processing method and apparatus, a program product, a computer device, and a medium.

### BACKGROUND OF THE DISCLOSURE

Artificial intelligence (AI) is a theory, a method, a technology, and an application system that use a digital computer or a machine controlled by the digital computer to simulate, extend, and expand human intelligence, so as to sense an environment, obtain knowledge, and obtain an optimal result with knowledge. Machine learning (ML) in AI is applied to all aspects of life.

In an existing application, during prediction of a conversion index of a user for a resource (such as software or advertising), a prediction network usually may be trained by using an existing conversion behavior of the user for the resource, and the conversion index of the user for the resource is predicted by using the trained prediction network. However, if a user has no conversion behavior for a resource or a resource has no conversion behavior from a user, features of the user and the resource cannot be effectively transmitted during the training of the prediction network. As a result, the trained prediction network cannot accurately predict a conversion index of the user for the resource.

### SUMMARY

This application provides a data processing method and apparatus, a program product, a computer device, and a medium, which can improve accuracy of a trained prediction network, thereby accurately predicting a conversion index of an object for a resource by using the trained prediction network.

An aspect of this application provides a data processing method. The method is performed by a computer device, and includes:

obtaining a heterogeneous conversion graph, the heterogeneous conversion graph comprising N object nodes and M resource nodes, each object node representing an object, each resource node representing a resource, N and M being positive integers, wherein a connecting edge between an object node and a resource node represents a conversion behavior from an object corresponding to the object node to a resource corresponding to the resource node;

obtaining a homogeneous object graph corresponding to each of the N objects, the homogeneous object graph comprising a plurality of object feature nodes, each object feature node being configured to represent an object feature of the corresponding object;

obtaining a homogeneous resource graph corresponding to each of the M resources, the homogeneous resource graph comprising a plurality of resource feature nodes, each resource feature node being configured to represent a resource feature of the corresponding resource; and

training a prediction network based on the heterogeneous conversion graph, the homogeneous object graph of each object, and the homogeneous resource graph of each resource, to obtain a trained prediction network, the trained prediction network being configured to predict a conversion index of an object of interest for a resource of interest.

An aspect of this application provides a computer device, which includes a memory and a processor. The memory has a computer program stored therein. The computer program, when executed by the processor, causes the computer device to perform the method in the aspect of this application.

An aspect of this application provides a non-transitory computer-readable storage medium. The computer-readable storage medium has a computer program stored therein. The computer program includes program instructions. The program instructions, when executed by a processor of a computer device, cause the computer device to perform the method in the foregoing aspect of this application.

### BRIEF DESCRIPTION OF THE DRAWINGS

To describe technical solutions of this application or the related art more clearly, drawings required for describing embodiments or the related art are briefly described below. Apparently, the drawings in the following description show only some of the embodiments of this application, and a person of ordinary skill in the art may derive other drawings from these drawings without creative efforts.

FIG. 1 is a schematic structural diagram of a network architecture according to this application.

FIG. 2 is a schematic diagram of a scenario of data processing according to this application.

FIG. 3 is a schematic flowchart of a data processing method according to this application.

FIG. 4 is a schematic diagram of a scenario of generating a heterogeneous conversion graph according to this application.

FIG. 5 is a schematic diagram of a scenario of generating a homogeneous object graph according to this application.

FIG. 6 is a schematic diagram of a scenario of generating a homogeneous resource graph according to this application.

FIG. 7 is a schematic flowchart of a model training method according to this application.

FIG. 8 is a schematic diagram of a scenario of network training according to this application.

FIG. 9 is a schematic flowchart of a loss generation method according to this application.

FIG. 10 is a schematic diagram of a scenario of generating a predicted loss value according to this application.

FIG. 11 is a schematic diagram of a scenario of model training according to this application.

FIG. 12 is a schematic structural diagram of a data processing apparatus according to this application.

FIG. 13 is a schematic structural diagram of a computer device according to this application.

### DESCRIPTION OF EMBODIMENTS

Technical solutions of this application are clearly and completely described below with reference to drawings of this application. Apparently, described embodiments are merely some rather than all embodiments of this application. All other embodiments obtained by a person of ordinary skill in the art based on the embodiments of this application without creative efforts fall within the protection scope of this application.

This application involves technologies related to artificial intelligence (AI). The AI is a theory, a method, a technology, and an application system that use a digital computer or a machine controlled by the digital computer to simulate, extend, and expand human intelligence, so as to sense an environment, obtain knowledge, and obtain an optimal result with knowledge. In other words, the AI is a comprehensive technology in computer science and attempts to understand the essence of intelligence and produce a new intelligent machine that can react in a manner similar to human intelligence. The AI is to study the design principles and implementation methods of various intelligent machines, to enable the machines to have functions of sensing, reasoning, and decision-making.

The AI technology is a comprehensive discipline, and involves a wide range of fields including both hardware-level technologies and software-level technologies. Basic AI technologies generally include technologies such as a sensor, a dedicated AI chip, cloud computing, distributed storage, a big data processing technology, an operating/interaction system, and electromechanical integration. AI software technologies mainly include several major directions such as a computer vision technology, a speech processing technology, a natural language processing technology, and machine learning (ML)/deep learning.

This application mainly involves the ML in the AI. The ML is an interdisciplinary field, involving a plurality of disciplines such as the theory of probability, statistics, the approximation theory, convex analysis, and the theory of algorithm complexity. The ML specializes in how a computer simulates or realizes learning behaviors of humans to obtain new knowledge or skills, and reorganizes existing knowledge structures to keep improving performance thereof. The ML is the core of the AI and a fundamental way to make computers intelligent, which is applied in all fields of the AI. The ML and the deep learning generally include technologies such as an artificial neural network, a confidence network, reinforcement learning, transfer learning, inductive learning, and learning from demonstration.

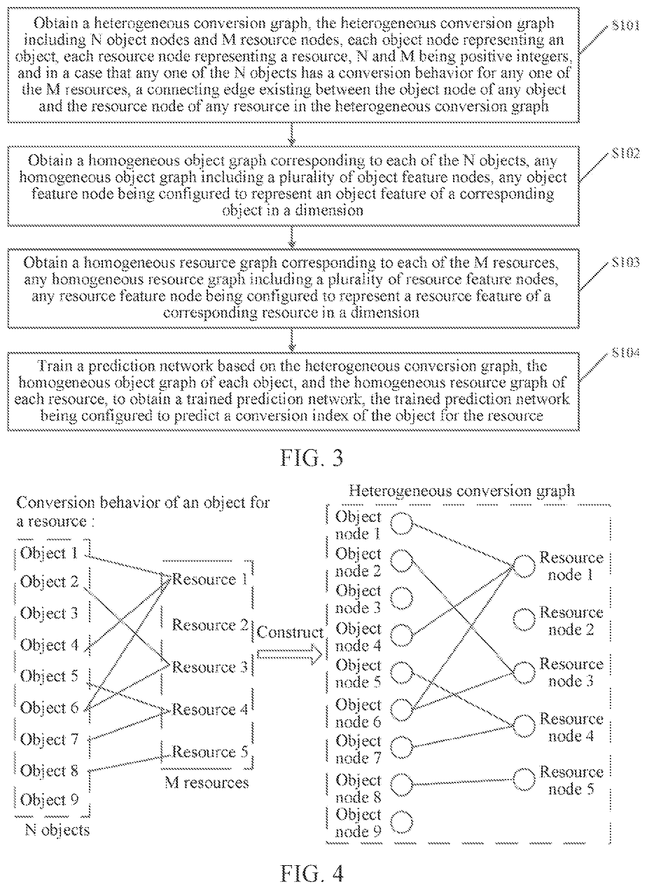

The ML involved in this application mainly means how to train a prediction model (that is, a prediction network) to predict a conversion index of an object for a resource through a trained predictive model. For details, reference may be made to the following description in an embodiment corresponding to FIG. 3.

This application involves a cloud technology. The cloud technology is a hosting technology that unifies a series of resources such as hardware, software, and a network in a wide area network or a local area network to implement calculation, storage, processing, and sharing of data.

The cloud technology is a collective name of a network technology, an information technology, an integration technology, a platform management technology, an application technology, and the like based on application of a cloud computing business model. The technologies may form a resource pool for use on demand, which is flexible and convenient. A cloud computing technology will become an important support. Backend services of a technology network system require a lot of computing and storage resources, such as a video website, a picture website, and more portal websites. With the rapid development and application of the Internet industry, each item may have its own identification mark in the future, and the identification marks are required to be transmitted to a background system for logical processing. Data of different levels will be processed separately, and all kinds of industry data require a strong system support, which can only be achieved through the cloud computing. The cloud technology involved in this application may mean that the backend can push resources to a front end of an object through the “cloud”.

First, in this application, a prompt interface or a pop-up window can be displayed before and during collection of relevant data of a user (user data such as a conversion behavior of a user for a resource and a feature of the user). The prompt interface or the pop-up window is used for prompting the user that the relevant data of the user is currently being collected. Therefore, in this application, the relevant step of obtaining the relevant data of the user is performed only after a confirmation operation performed by the user on the prompt interface or the pop-up window is obtained, or otherwise (that is, when the confirmation operation performed by the user on the prompt interface or the pop-up window is not obtained), the relevant step of obtaining the relevant data of the user is ended, that is, the relevant data of the user is not obtained. In other words, all user data collected in this application is collected with the consent and authorization of users, and the collection, use, and processing of relevant user data need to comply with relevant laws, regulations, and standards of relevant countries and regions.

Relevant concepts involved in this application are explained herein.

Conversion rate (CVR): It is probability of successfully converting an advertisement by a user after the advertisement is exposed. Successful conversion usually means behaviors such as completing a purchase of a target product. The CVR may be the following conversion index.

Homogeneous graph: It is a graph with only one type of vertices and edges.

Heterogeneous graph: It is a graph with two or more types of vertices and edges.

Bipartite graph: It is a graph in which a vertex set may be divided into two subsets that do not intersect each other, vertices (such as object nodes or resource nodes described below) at both ends of each edge belong to two different subsets, and the vertices in the same subset are not adjacent.

Self-supervised: It is a method of directly obtaining a supervised signal from unlabeled data for learning without manual labeling of data.

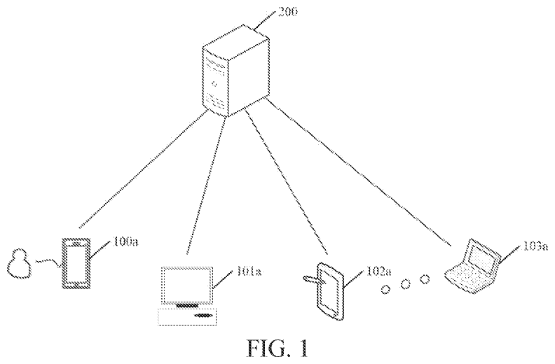

FIG. 1 is a schematic structural diagram of a network architecture according to this application. As shown in FIG. 1, the network architecture may include a server 200 and a terminal device cluster. The terminal device cluster may include one or more terminal devices. A quantity of the terminal devices is not limited herein. As shown in FIG. 1, the plurality of terminal devices may specifically include a terminal device 100a, a terminal device 101a, a terminal device 102a, . . . , a terminal device 103a. As shown in FIG. 1, the terminal device 100a, the terminal device 101a, the terminal device 102a, . . . , the terminal device 103a all may establish a network connection to the server 200, so that each terminal device can communicate with the server 200 through the network connection.

The server 200 shown in FIG. 1 may be an independent physical server, a server cluster composed of a plurality of physical servers, a distributed system, or a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal device may be a smart terminal such as a smartphone, a tablet computer, a laptop computer, a desktop computer, a smart television, and an on-board terminal. The embodiments of this application are described in detail below by using communication between the terminal device 100a and the server 200 as an example.

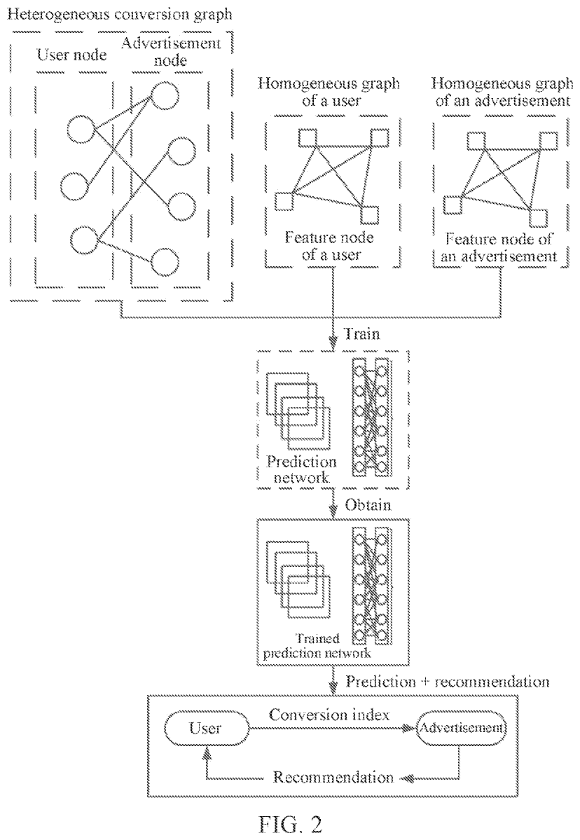

FIG. 2 is a schematic diagram of a scenario of data processing according to this application. As shown in FIG. 2 the terminal device 100a, the terminal device 101a, the terminal device 102a, . . . , the terminal device 103a each may be a terminal device owned by each user (which may be the following object). The terminal device may include an application. An application page of the application may display a plurality of advertisements (which may be the following resource). The user may purchase a product recommended in an advertisement on the application page of the application through the terminal device owned by the user. The server 200 may be a backend server of the application. The server 200 can obtain a purchase behavior (which may be referred to as a conversion behavior of the user for the advertisement) of the user for the product recommended in the advertisement. Further, the server 200 can construct a heterogeneous conversion graph through a purchase behavior of each user for a product in each advertisement. The heterogeneous conversion graph includes a user node of the user and an advertisement node of the advertisement. If a user has a purchase behavior for a product in an advertisement, a connecting edge exists between a user node of the user and an advertisement node of the advertisement in the heterogeneous conversion graph.

The server 200 can further construct a homogeneous graph corresponding to each user based on an object feature of each user (including a feature node of the user, which may be referred to as an object feature node), and construct a homogeneous graph corresponding to each advertisement based on an advertisement feature of each advertisement (including a feature node of the advertisement, which may be referred to as a resource feature node).

The server 200 can train a prediction network in combination with the foregoing heterogeneous conversion graph, homogeneous graph of each user, and homogeneous graph of each advertisement, to obtain a trained prediction network. The trained prediction network may be configured to predict a conversion index of a user for an advertisement. The conversion index represents a rate that the user purchases a product recommended in the advertisement. For the process, reference may be made to the following relevant description in the embodiment corresponding to FIG. 3.

In this application, by training the prediction network in combination with the heterogeneous conversion graph, the homogeneous graph of each user, and the homogeneous graph of each advertisement, the prediction network can effectively learn a feature corresponding to an isolated node (a user node or an advertisement node) in the heterogeneous conversion graph, which improves accuracy of the trained prediction network, and improves accuracy of predicting the conversion index of the user for the advertisement.

FIG. 3 is a schematic flowchart of a data processing method according to this application. An execution body in this embodiment of this application may be a computer device or a computer device cluster composed of a plurality of computer devices. The computer device may be a server or a terminal device. Description is provided below by using an example in which the execution body in this application is collectively referred to as a computer device. As shown in FIG. 3, the method may include the following steps:

Step S101: Obtain a heterogeneous conversion graph, the heterogeneous conversion graph including N object nodes and M resource nodes, each object node representing an object, each resource node representing a resource, N and M being positive integers, and when any one of the N objects has a conversion behavior for any one of the M resources, a connecting edge existing between the object node of any object and the resource node of any resource in the heterogeneous conversion graph.

The computer device can obtain the heterogeneous conversion graph. As the name suggests, the heterogeneous conversion graph is a heterogeneous graph. The heterogeneous conversion graph may include N object nodes and M resource nodes. Each object node represents one object, and each resource node represent one resource. In other words, there are N objects and M resources. One object may have one object node in the heterogeneous conversion graph, and one resource may have one resource node in the heterogeneous conversion graph. N and M are positive integers. Specific values of N and M are determined based on an actual application scenario, which is not limited. The N objects and the M resources may be objects and resources in any application platform.

The object may be a user, and the resource may be any data that may be recommended or pushed to the user. For example, the resource may be advertisement data. The advertisement data may be used for recommending a corresponding product to the user. The product may be a product that may be purchased (such as a shampoo, a hand cream, a sun hat, or sunglasses), or may be an application that may be downloaded and installed (such as software (app)). Specific data of the resource may be determined based on an actual application scenario, which is not limited.

If any one of the N objects has a conversion behavior for any one of the M resources, a connecting edge exists between the object node of any object and the resource node of any resource in the heterogeneous conversion graph (in other words, the object node and the resource node are connected to each other in the heterogeneous conversion graph). In other words, if an object has a conversion behavior for a resource, a connecting edge (connected to each other) exists between the object node of the object and the resource node of the resource in the heterogeneous conversion graph.

The conversion behavior of the object for the resource may be determined based on an actual application scenario. For example, if the resource is advertisement data for a product, the conversion behavior of the object for the resource may be that the object purchases a product recommended in the advertisement data. For another example, if the resource is recommendation data of software (which may also belong to advertisement data), the conversion behavior of the object for the resource may be that the object downloads and installs the software recommended in the recommendation data.

The foregoing heterogeneous conversion graph is a non-full bipartite graph (to be specific, vertices are not fully connected). The heterogeneous conversion graph includes two types of vertices (that is, nodes): the object node of the object and the resource node of the resource. In the heterogeneous conversion graph, if an object has a conversion behavior for a resource, a connecting edge exists between the object node of the object and the resource node of the resource in the heterogeneous conversion graph. If the object has no conversion behavior for the resource, no connecting edge exists between the object node of the object and the resource node of the resource in the heterogeneous conversion graph.

FIG. 4 is a schematic diagram of a scenario of generating a heterogeneous conversion graph according to this application. As shown in FIG. 4, the foregoing N objects may include an object 1 to an object 9, and the foregoing M resources may include a resource 1 to a resource 5. The object 1 has a conversion behavior for the resource 1, and therefore a connecting edge exists between an object node 1 of the object 1 and a resource node 1 of the resource 1 in the heterogeneous conversion graph. The object 2 has a conversion behavior for the resource 3, and therefore a connecting edge exists between an object node 2 of the object 2 and a resource node 3 of the resource 3 in the heterogeneous conversion graph. The object 3 has no conversion behavior for any resource, and therefore no connecting edge exists between an object node 3 of the object 3 and a resource node of any resource in the heterogeneous conversion graph.

Moreover, the object 4 has a conversion behavior for the resource 1, and therefore a connecting edge exists between an object node 4 of the object 4 and the resource node 1 of the resource 1 in the heterogeneous conversion graph. The object 5 has a conversion behavior for the resource 4, and therefore a connecting edge exists between an object node 5 of the object 5 and a resource node 4 of the resource 4 in the heterogeneous conversion graph. The object 6 has a conversion behavior for the resource 1 and the resource 3, and therefore a connecting edge exists between an object node 6 of the object 6 and the resource node 1 of the resource 1 and a connecting edge exists between the object node 6 of the object 6 and the resource node 3 of the resource 3 in the heterogeneous conversion graph. The object 7 has a conversion behavior for the resource 4, and therefore a connecting edge exists between an object node 7 of the object 7 and the resource node 4 of the resource 4 in the heterogeneous conversion graph.

Moreover, the object 8 has a conversion behavior for the resource 5, and therefore a connecting edge exists between an object node 8 of the object 8 and a resource node 5 of the resource 5 in the heterogeneous conversion graph. The object 9 has no conversion behavior for any resource, and therefore no connecting edge exists between an object node 9 of the object 9 and the resource node of any resource in the heterogeneous conversion graph.

Step S102: Obtain a homogeneous object graph corresponding to each of the N objects, any homogeneous object graph including a plurality of object feature nodes, any object feature node being configured to represent an object feature of a corresponding object in a dimension.

The computer device can obtain the homogeneous graph corresponding to each of the foregoing N objects. The homogeneous graph of the object may be referred to as a homogeneous object graph, and one object may have one homogeneous object graph. Any homogeneous object graph may include a plurality of feature nodes. The feature nodes in the homogeneous object graph may be referred to as object feature nodes, and any object feature node is configured to represent an object feature of a corresponding object in a dimension.

The homogeneous object graph of the object may be a full graph. To be specific, any two object feature nodes in any homogeneous object graph may be connected to each other.

For example, the object may have object features in a plurality of dimensions (that is, multiple dimensions). The object features in multiple dimensions may include an age feature of the object, a city feature of the object, and a job feature of the object. In this case, the homogeneous object graph of the object may include an age feature node of the object, a city feature node of the object, and a job feature node of the object.

A specific one of the object features in multiple dimensions of the object may be set based on an actual application scenario. An object feature in one dimension of the object may correspond to one object feature node in the homogeneous object graph of the object. Object features in multiple dimensions of different objects may be the same or different, which is specifically determined based on an actual application scenario.

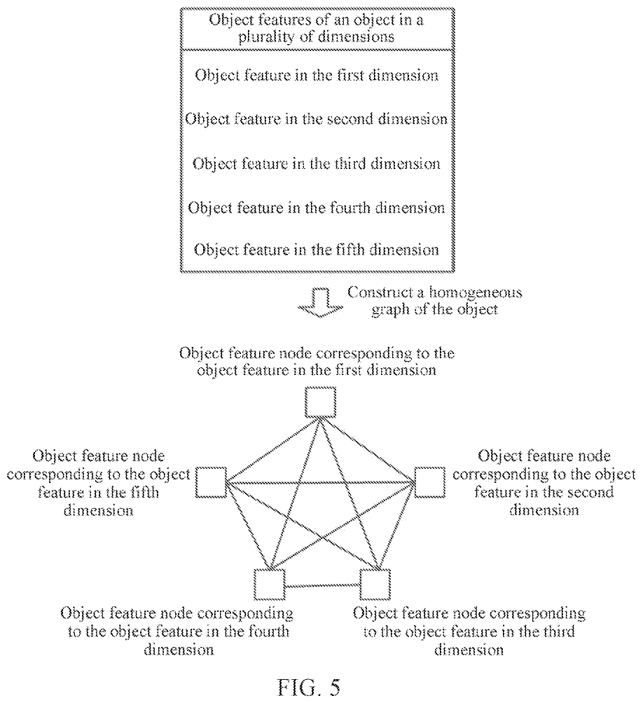

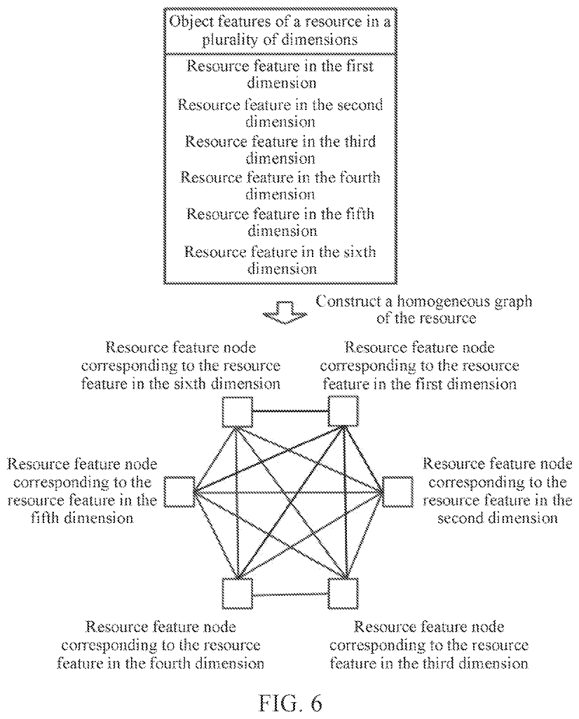

FIG. 5 is a schematic diagram of a scenario of generating a homogeneous object graph according to this application. If an object has object features in a plurality of dimensions (including the first dimension to the fifth dimension), a constructed homogeneous object graph of the object may include an object feature node corresponding to the object feature of the object in the first dimension, an object feature node corresponding to the object feature of the object in the second dimension, an object feature node corresponding to the object feature of the object in the third dimension, an object feature node corresponding to the object feature of the object in the fourth dimension, and an object feature node corresponding to the object feature of the object in the fifth dimension. The 5 object feature nodes are connected in pairs.

Step S103: Obtain a homogeneous resource graph corresponding to each of the M resources, any homogeneous resource graph including a plurality of resource feature nodes, any resource feature node being configured to represent a resource feature of a corresponding resource in a dimension.

The computer device can obtain the homogeneous graph corresponding to each of the foregoing M resources. The homogeneous graph of the resource may be referred to as a homogeneous resource graph, and one resource may have one homogeneous resource graph. Any homogeneous resource graph may include a plurality of feature nodes. The feature nodes in the homogeneous resource graph may be referred to as resource feature nodes, and any resource feature node is configured to represent a resource feature of a corresponding resource in a dimension.

The homogeneous resource graph of the resource may be a full graph. To be specific, any two resource feature nodes in any homogeneous resource graph may be connected to each other.

For example, the resource may have resource features in a plurality of dimensions (that is, multiple dimensions). The resource features in multiple dimensions may include a resource style feature of the resource, a resource field feature, and a resource type feature. In this case, the homogeneous resource graph of the resource may include a resource style feature node, a resource field feature node, and a resource type feature node.

A specific one of the resource features in multiple dimensions of the resource may be set based on an actual application scenario. A resource feature in one dimension of the resource may correspond to one resource feature node in the homogeneous resource graph of the resource. Resource features of different resources in multiple dimensions may be the same or different, which is specifically determined based on an actual application scenario.

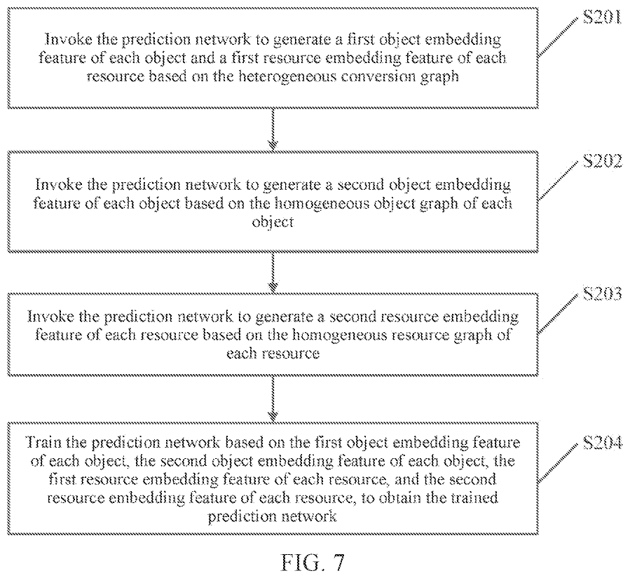

FIG. 6 is a schematic diagram of a scenario of generating a homogeneous resource graph according to this application. If a resource has resource features in a plurality of dimensions (including the first dimension to the sixth dimension), a constructed homogeneous resource graph of the resource may include a resource feature node corresponding to the resource feature of the resource in the first dimension, a resource feature node corresponding to the resource feature of the resource in the second dimension, a resource feature node corresponding to the resource feature of the resource in the third dimension, a resource feature node corresponding to the resource feature of the resource in the fourth dimension, a resource feature node corresponding to the resource feature of the resource in the fifth dimension, and a resource feature node corresponding to the resource feature of the resource in the sixth dimension. The 6 resource feature nodes are connected in pairs.

Step S104: Train a prediction network based on the heterogeneous conversion graph, the homogeneous object graph of each object, and the homogeneous resource graph of each resource, to obtain a trained prediction network, the trained prediction network being configured to predict a conversion index of the object for the resource.

The heterogeneous conversion graph includes a conversion relationship between the object and the resource. The homogeneous graph of the object represents the feature of the object, and the homogeneous graph of the resource represents the feature of the resource. The computer device can train the prediction network based on the foregoing heterogeneous conversion graph, homogeneous object graph of each object, and homogeneous resource graph of each resource that are obtained, to obtain the trained prediction network. For a specific process of training the prediction network, reference may be made to the following relevant description in an embodiment corresponding to FIG. 7.

The trained prediction network may be configured to predict a conversion index of an object for a resource. The conversion index represents a probability that the object performs a conversion behavior on the resource. The computer device can determine a policy for pushing a resource (referred to as a resource push policy for short) for each object based on the predicted conversion index of each object for each resource. A larger conversion index of an object for a resource indicates a larger probability that the object performs a conversion behavior on the resource. On the contrary, a smaller conversion index of an object for a resource indicates that a smaller probability that the object performs a conversion behavior on the resource.

For example, the computer device can obtain a prediction object and a prediction resource. The prediction object may be any one of the foregoing N objects, or may be a new object (in other words, the prediction object is none of the N objects). Similarly, the prediction resource may be any one of the foregoing M resources, or may be a new resource (in other words, the prediction resource is none of the M resources).

The computer device can obtain an object identifier (object id) of the prediction object and a resource identifier (resource id) of the prediction resource, and can map the object id of the prediction object and the resource id of the prediction resource to a uniform hash space. The hash space may be the same as a hash space to which the object ids of the N objects and the resource ids of the M resources are mapped in the following step S201. For a detailed explanation, reference may be made to a description in the following step S201.

The computer device can obtain an object label feature of the prediction object and a resource label feature of the prediction resource. A process of obtaining the object label feature of the prediction object is the same as a process of obtaining an object label feature of each object in the following step S202. A process of obtaining the resource label feature of the prediction resource is the same as a process of obtaining a resource label feature of each resource in the following step S203.

The computer device can input a feature value of the prediction object mapped in the hash space, the object label feature of the prediction object, a feature value of the prediction resource mapped in the hash space, and the resource label feature of the prediction resource into the trained prediction network, and invoke the prediction network to predict a conversion index of the prediction object for the prediction resource based on the feature value of the prediction object mapped in the hash space, the object label feature of the prediction object, the feature value of the prediction resource mapped in the hash space, and the resource label feature of the prediction resource. The conversion index may be a value from 0 to 1.

If the conversion index of the prediction object for the prediction resource is greater than a conversion index threshold, the prediction resource may be pushed to the prediction object.

A plurality of prediction resources may exist. For example, the prediction resource may include each of the foregoing M resources. In this case, the computer device can obtain a conversion index of the prediction object for each prediction resource, rank the prediction resources in descending order based on the conversion index corresponding to each prediction resource, and push top T resources of the resources to the prediction object. T is a positive integer, and a specific value of T may be determined based on an actual application scenario.

This application focuses on describing how to accurately train the prediction network and generate an accurate conversion index of an object for a resource through the trained prediction network. A specific policy of subsequently pushing the resource to the object through the conversion index of the object for the resource may be determined based on an actual application scenario, which is not limited.

In this application, the prediction network is trained in combination the heterogeneous conversion graph between the object and the resource and the homogeneous graph of the object and the homogeneous graph of the resource, so that the prediction network can effectively learn the feature of the object or the resource corresponding to the isolated node (such as a node having no connecting edge or few connecting edges with other resource nodes or object nodes) in the heterogeneous conversion graph. In this way, a cold start problem of the object and the resource (such as a problem of insufficient learning to a new object or resource when the new object or resource exists and insufficient learning to some existing objects or resources associated with other objects or resources to only a small degree (such as an object or a resource having no or very few corresponding connecting edges in the heterogeneous conversion graph)) can be resolved. Therefore, the trained prediction network can accurately predict conversion indexes of all objects for all resources.

In this application, the heterogeneous conversion graph can be obtained, the heterogeneous conversion graph including the object nodes of the N objects and the resource nodes of the M objects, N and M being positive integers, and when any one of the N objects has a conversion behavior for any one of the M resources, a connecting edge existing between the object node of any object and the resource node of any resource in the heterogeneous conversion graph; the homogeneous object graph corresponding to each of the N objects can be obtained, any homogeneous object graph including a plurality of object feature nodes, any object feature node being configured to represent an object feature of a corresponding object in a dimension; the homogeneous resource graph corresponding to each of the M resources can be obtained, any homogeneous resource graph including a plurality of resource feature nodes, any resource feature node being configured to represent a resource feature of a corresponding resource in a dimension; the prediction network can be trained based on the heterogeneous conversion graph, the homogeneous object graph of each object, and the homogeneous resource graph of each resource, to obtain the trained prediction network; and the trained prediction network can be configured to predict the conversion index of the object for the resource. It may be learned that, according to the method provided in this application, the prediction network can be trained in combination with the heterogeneous graph of the object and the resource, the homogeneous graph of the object, and the homogeneous graph of the resource, so that the features of each object and each resource (including both objects and resources between which no access behavior occurs and objects and resources between which an access behavior occurs) can be effectively propagated during the training of the prediction network. Therefore, accuracy of the trained prediction network can be improved, and the trained prediction network can accurately predict the conversion index of the object for the resource.

FIG. 7 is a schematic flowchart of a model training method according to this application. An execution body in this embodiment of this application may be the same as the execution body in the embodiment corresponding to FIG. 3. As shown in FIG. 6, the method includes the following steps:

Step S201: Invoke the prediction network to generate a first object embedding feature of each object and a first resource embedding feature of each resource based on the heterogeneous conversion graph.

First, the computer device can obtain an object id of each object and a resource id of each resource. The computer device can map the object id of each object and the resource id of each resource to a uniform hash space. For example, the object id of each object and the resource id of each resource can be mapped to the uniform hash space by performing operations on the object id of each object and the resource id of each resource through a specific hash algorithm. The object id of an object is mapped to a hash value in the hash space, and the resource id of a resource is also mapped to a hash value in the hash space.

The computer device can represent the heterogeneous conversion graph as a relationship matrix through the hash values of each resource and each object mapped in the hash space. In the relationship matrix, a horizontal direction includes the resources, and a vertical direction includes the objects. If a connecting edge exists between the object node of an object and the resource node of a resource in the heterogeneous conversion graph, a value of an element at a position corresponding to the object and the resource in the relationship matrix is 1. Otherwise (to be specific, no connecting edge exists), the value of the element at the position corresponding to the object and the resource in the relationship matrix are 0. For example, if the first row in the relationship matrix represents the object 1, the first column represents the resource 1, and the object 1 has a conversion behavior for the resource 1, a value of an element at a position of the first row and the first column in the relationship matrix is 1. If the object 1 has no conversion behavior for the resource 1, the value of the element at the position of the first row and the first column in the relationship matrix is 0. In other words, the relationship matrix is configured to indicate a connecting edge relationship between each resource node and each object node in the heterogeneous conversion graph.

A matrix space of the relationship matrix is the foregoing hash space to which the object id and resource id are mapped. Horizontal positions in the relationship matrix may include positions corresponding to the hash values to which the resource ids may be mapped. Vertical positions in the relationship matrix may include hash values to which the object ids may be mapped. The relationship matrix may further include positions to which none of the N objects and the M resources is mapped. In other words, a plurality of elements having values of 0 may exist in the relationship matrix. New objects and new resources can be further mapped to positions of the elements existing in the relationship matrix having values of 0. Therefore, it may be understood that, by mapping both the object id of the object and the resource id of the resource to the uniform hash space, the prediction network can still identify and map a new object and resource to the corresponding positions in the hash space even if the new object and resource do not appear during the training of the prediction network but appear during application of the prediction network. In other words, the prediction network can identify and predict a new object and resource the prediction network never meets, which can improve a prediction range and prediction accuracy of the prediction network for the object and the resource.

The relationship matrix representing the heterogeneous conversion graph may be denoted as R. The computer device can further obtain an adjacency matrix of the relationship matrix R. The adjacency matrix may be represented as A. As shown in the following formula (1), the adjacency matrix A is:

$$A = [ \begin{matrix}0 & R \\ {R}^{T} & 0\end{matrix} ] . \qquad ( 1 )$$

R^{T} represents transpose of the relationship matrix R.

It may be understood that, a structure of the heterogeneous conversion graph is a structure of the adjacency matrix A, and the adjacency matrix A is a symmetric matrix. In this application, the heterogeneous conversion graph may be represented as the adjacency matrix A. The adjacency matrix A has recorded therein a conversion behavior of each object included in the heterogeneous conversion graph for each resource, so that operations can be easily performed in the prediction network through the adjacency matrix.

The computer device can input the adjacency matrix A into the prediction network.

A process of invoking the prediction network to generate the embedding feature of each object and the embedding feature of each resource based on the adjacency matrix A may be as follows:

The prediction network may include an NGCF (a graph neural network). The NGCF can effectively propagate information between the nodes in the heterogeneous graph. Therefore, in this application, the first object embedding feature of the object and the first resource embedding feature of the resource may be generated by invoking the NGCF in the prediction network. The process may include the following: The computer device may invoke the NGCF to obtain a feature propagation matrix, the feature propagation matrix being configured to propagate the information between the feature (including the resource feature and the object feature) corresponding to each node (including the resource node and the object node) in the heterogeneous conversion graph, and then generate an embedding feature matrix corresponding to the N objects and the M resources, as shown in the following formula (2) to formula (4):

E^{(k+1)}=σ((I+L)E^{(k)}W₁+(LE^{(k)})⊙E^{(k)}W₂) (2)

L=D^{1/2}AD^{1/2} (3)

Ê=E⁽⁰⁾∥E⁽¹⁾∥E⁽²⁾|E⁽³⁾∥E (4).

The NGCF herein may have 4 (or another quantity of) network layers for feature learning and generation. Based on the formula (2), a value of k may range from 0 to 3. The first network layer for feature learning and generation can generate a feature matrix E⁽¹⁾ based on E⁽⁰⁾. The second network layer for feature learning and generation can generate a feature matrix E⁽²⁾ based on E⁽¹⁾. The third network layer for feature learning and generation can generate a feature matrix E⁽³⁾ based on E⁽²⁾. The fourth network layer for feature learning and generation can generate a feature matrix E⁽⁴⁾ based on E⁽³⁾.

σ represents an activation function. L represents the foregoing feature propagation matrix, and L is a graph Laplacian matrix, which is used for information propagation between nodes. D represents a matrix of degree. D has recorded therein a degree of each node (including the object node and the resource node) in the heterogeneous conversion graph. The degree of a node is equal to a quantity of other nodes with which the node has a connecting edge. I represents an identity matrix. W₁ and W₂ are both parameter matrices (which are also used for information propagation between nodes) in the NGCF. During the constant training of the prediction network, W₁ and W₂ are constantly updated and corrected.

Further, E⁽¹⁾ to E⁽⁴⁾ may be obtained through the foregoing formula (2) and formula (3). The obtained E⁽¹⁾ to E⁽⁴⁾ may be used as the embedding feature matrix. ∥ in the formula (4) represents splicing. To be specific, a spliced embedding feature matrix Ê may be obtained by splicing a plurality of embedding feature matrices (including E⁽⁰⁾ to E⁽⁴⁾).

E⁽⁰⁾ to E⁽⁴⁾ are embedding feature matrices. Any embedding feature matrix includes the embedding feature (which may be a feature vector) corresponding to each node in the heterogeneous conversion graph. For initial training of the prediction network (that is, the first training). E⁽⁰⁾ is an initialized embedding feature matrix. The initialized embedding feature matrix includes an initialized embedding feature corresponding to each object and an initialized embedding feature corresponding to each resource. The initialized embedding feature corresponding to each object and the initialized embedding feature corresponding to each resource may be obtained by random initialization. In addition, the prediction network may be constantly iteratively trained, and the prediction network can generate E⁽¹⁾ to E⁽⁴⁾ during each iterative training. Therefore, during the iterative training of the prediction network, for non-initial training (that is, non-first training) of the prediction network, E⁽⁰⁾ during next iterative training may be E⁽⁴⁾ during previous iterative training.

If each embedding feature in E⁽⁰⁾ to E⁽⁴⁾ (one node in the heterogeneous conversion graph corresponds to one embedding feature in one embedding feature matrix) has 16 (or another quantity of) dimensions, embedding features in the spliced embedding feature matrix Ê are 16*5 dimensions, that is, 80 dimensions in total. Therefore, feature dimension reduction may be performed on the spliced embedding feature matrix Ê (in other words, feature mapping processing is performed, which may be implemented in a multilayer perceptron (MLP) through a mapping matrix, and the mapping matrix may also be obtained by training), to obtain a target embedding feature matrix. The target embedding feature matrix is obtained by performing feature dimension reduction on the spliced embedding feature matrix Ê. The target embedding feature matrix includes the embedding feature of each object and the embedding feature of each resource. Each embedding feature included in the target embedding feature matrix may have 16 dimensions.

Further, the computer device can extract the embedding feature of each object from the target embedding feature matrix as a first object embedding feature of each object. One object has one first object embedding feature. The computer network can further extract the embedding feature of each resource from the target embedding feature matrix as a first resource embedding feature of each resource. One resource has one first resource embedding feature.

The first object embedding feature of each object and the first resource embedding feature of each resource are respectively the embedding feature of each object and the embedding feature of each resource generated by the prediction network through the heterogeneous conversion graph. During the iterative training of the prediction network, the first object embedding feature of each object and the first resource embedding feature of each resource can be generated during each training (which may be understood as each round of training) of the prediction network.

Step S202: Invoke the prediction network to generate a second object embedding feature of each object based on the homogeneous object graph of each object.

The prediction network may further include an inductive learning network, which is also referred to as a graph attention network (GAT). The GAT has a good inductive learning capability. Therefore, the computer network may invoke the GAT in the prediction network to generate the embedding feature of each object (which may be referred to as a second object embedding feature) based on the homogeneous object graph of each object.

Since the process of generating the second object embedding feature of each object through the GAT is the same, a description is provided below by using an example of generating the second object embedding feature of a target object through the GAT. The target object may be any one of the N objects. Refer to the following description.

A connecting edge exists between any two object feature nodes in the homogeneous object graph of the target object (that is, the homogeneous object graph is a fully connected graph).

The computer device can represent the homogeneous object graph of the target object as a corresponding adjacency matrix (a process of obtaining the adjacency matrix of the homogeneous object graph of the target object is the same as the foregoing process of obtaining the adjacency matrix of the heterogeneous conversion graph). The computer device can represent the adjacency matrix of the homogeneous object graph of the target object as A_{D}. The computer device can input the adjacency matrix A_{D} into the prediction network.

Further, the computer device can input the object label feature of each object (which may be represented as a vector) into the prediction network.

The object label feature of each object may be obtained through the specific object feature of each object in each dimension (reflected by the feature value of the object feature in each dimension). For example, an object has object features in 3 dimensions, and a feature space of any one of the 3 dimensions is 1000 (that is, an object feature in one dimension has 1000 values, that is, has 1000 feature values). In this case, the object label feature of the object may be composed of the feature values of the object features of the object in the 3 dimensions.

For example, an object has object features in 3 dimensions. The object features in the 3 dimensions respectively correspond to an age feature of the object, a city feature of the object, and a job feature of the object. A magnitude of a feature space of each of the object features in the 3 dimensions may be 1000. In other words, the age feature of the object may have 1000 feature values that can be selected. The 1000 feature values that can be selected may include mapping values (the mapping values may be understood as identifiers used for representing ages, and one age may correspond to one mapping value) corresponding to 0 years old to 999 years old. The city feature of the object may have 1000 feature values that can be selected. The 1000 feature values that can be selected may include mapping values (the mapping values may be understood as identifiers used for representing cities, and one city may correspond to one mapping value) corresponding to 1000 cities. Similarly, the job feature of the object may have 1000 feature values that can be selected. The 1000 feature values that can be selected may include mapping values (that mapping values may be understood as identifiers used for representing jobs, and one job may correspond to one mapping value) corresponding to 1000 jobs. Therefore, if an age of an object (for example, the object 1) is 20 years old, a mapping value corresponding to 20 years old is 0.3, a city of the object 1 is Chongqing, a mapping value corresponding to Chongqing is 0.5, a job of the object 1 is a freelancer, and a mapping value corresponding to the freelancer is 0.2, the object label feature of the object 1 may be (0.3, 0.5, 0.2).

Each feature value (that is, a mapping value) in each dimension may be obtained by mapping the corresponding object feature to the uniform hash space. An object feature in one dimension may correspond to one hash space. By mapping a plurality of object features in all dimensions to the corresponding hash spaces, it can be ensured that the object features in all dimensions (one feature value can represent one corresponding object feature) are all controllable. Moreover, it can be ensured that a new object feature (for example, an object feature indicated by a feature value in a dimension that is not used during training but used during actual prediction) is in a preset feature space (that is, the hash space). In other words, the prediction network can identify all object features in all dimensions in the hash space.

For example, for the age feature of the object, all ages that can be selected as the age of the object may be mapped to the hash space through a specific hash algorithm (a specific expression of the algorithm may be determined based on an actual application scenario). For example, the ages that can be selected as the age of the object include 0 years old to 999 years old. In this case, a hash operation may be performed on a total of 1000 ages from 0 to 999 to obtain mapping values (which are hash values) corresponding to the ages. The mapping values corresponding to the ages are feature values that can be selected in the age feature dimension of the object.

Therefore, the process of generating the second object embedding feature of the target object may be as follows: The computer device can invoke the GAT to delete connecting edges in the homogeneous object graph of the target object to obtain an activation subgraph of the homogeneous object graph of the target object. The activation subgraph of the homogeneous object graph of the target object may be referred to as a first activation subgraph. The first activation subgraph is obtained by removing connecting edges between object feature nodes in the homogeneous object graph of the target object that are associated with each other to only a small degree. The first activation subgraph is a non-fully connected graph. The first activation subgraph may be represented as a relationship matrix obtained after deleting the connecting edges in the homogeneous object graph of the target object. Then an adjacency matrix of the first activation subgraph may be obtained. A process of obtaining the adjacency matrix of the first activation subgraph is the same as the foregoing process of obtaining the adjacency matrix of the heterogeneous conversion graph. As shown in the following formula (5) to formula (7), the process may be:

$$= \{ \begin{matrix}1 , & {M}_{i , j} \geq {Rank}_{ϵ {n}^{2}} ( M ) \\ 0 , & Otherwise\end{matrix} \qquad ( 5 )$$

$${M}_{i , j} = cos ( {\hat{h}}_{i} , {\hat{h}}_{j} ) \qquad ( 6 )$$

$$\hat{H} = {W}_{3} H + {b}_{3} . \qquad ( 7 )$$

M_{i,j} represents a degree of association (which may be understood as a similarity) between an i^{th} object feature node and a j^{th} object feature node in the homogeneous object graph of the target object. The i^{th} object feature node and the j^{th} object feature node may be any two object feature nodes in the homogeneous object graph of the target object.

Ĥ is a feature matrix of each object feature node in the homogeneous object graph of the target object. Ĥ includes an embedding feature corresponding to each object feature node. [symbol] represents an embedding feature in Ĥ corresponding to the i^{th} object feature node. [symbol] represents an embedding feature in Ĥ corresponding to the j^{th} object feature node. cos( [symbol] , [symbol] ) represents a cosine distance between [symbol] and [symbol] .

[symbol] represents the adjacency matrix of the first activation subgraph. ϵ represents a quantity of connecting edges in the homogeneous object graph of the target object that need to be retained (which is also used for indicating a quantity of connecting edges in the homogeneous object graph of the target object that need to be deleted). For example, ϵ is 30 (or may be another value, which is specifically determined based on an actual application scenario). Degrees of association between the object feature nodes in the homogeneous object graph of the target object may be ranked. Connecting edges between object feature nodes whose degrees of association are located within top 30% of the degrees of association are retained. In other words, connecting edges between object feature nodes whose degrees of association are located within remaining 70% of the degrees of association are deleted. A degree of association exists between any two object feature nodes. In other words, any connecting edge corresponds to one degree of association.

For example, if ϵ is 30, and a degree of association between an object feature node 1 and an object feature node 2 in the homogeneous object graph of the target object is located in the top 30% of the degrees of association between all object feature nodes, a connecting edge between the object feature node 1 and the object feature node 2 in the homogeneous object graph of the target object may be retained. Otherwise, if the degree of association between the object feature node 1 and the object feature node 2 in the homogeneous object graph of the target object is located in the remaining 70% of the degrees of association between all object feature nodes, the connecting edge between the object feature node 1 and the object feature node 2 in the homogeneous object graph of the target object may be deleted. It may be understood that, the first activation subgraph includes the connecting edges between the object feature nodes in the homogeneous object graph of the target object whose degrees of association are located within the top 30%.

Therefore, M_{i,j}≥Rank_{ϵn}_{²}(M) represents the connecting edges between the object feature nodes in the homogeneous object graph of the target object whose degrees of association are located within top ϵ %. In other words, the first activation subgraph includes the connecting edges between the object feature nodes in the homogeneous object graph of the target object whose degrees of association are located within the top ϵ %. The foregoing formula (5) indicates that only the object feature nodes in the adjacency matrix of the first activation subgraph whose degrees of association are located within the top ϵ % have a connection relationship (that is, connecting edges exist therebetween in the first activation subgraph). On the contrary, the object feature nodes whose degrees of association are located outside the top ϵ % have no connecting relationship.

Further, it may be understood that, during the initial training (that is, the first training) of the prediction network, H represents an initialized feature matrix. H includes an initialized embedding feature corresponding to the object feature of the target object in each dimension. In other words, H includes the initialized embedding feature corresponding to each object feature node in the homogeneous object graph of the target object. An object feature in one dimension corresponds to one initialized embedding feature. In other words, one object feature node corresponds to one initialized embedding feature. The initialized embedding feature in H corresponding to each object feature node may be obtained by random initialization.

The computer device can obtain the initialized embedding feature corresponding to each object feature node through the object label feature of the target object. It may be understood that, an association relationship between a feature value (that is, the foregoing mapping value) of the object feature of the target object in each dimension and the corresponding initialized embedding features may be pre-established. One feature value corresponds to one initialized embedding feature. Since an object feature in one dimension corresponds to one object feature node, and an object feature in one dimension also corresponds to one initialized embedding feature, one object feature node corresponds to one initialized embedding feature. The initialized embedding feature is an initialized embedding feature corresponding to the object feature in the dimension indicated by the object feature node.

Therefore, the computer device can obtain the initialized embedding features with an association relationship through the feature value corresponding to the object feature in each dimension included in the object label feature of the target object, which are used as the initialized embedding features respectively corresponding to the object feature nodes of the target object.

In addition, the prediction network may be constantly iteratively trained, and the prediction network can generate Ĥ through the logic of the formula (7) during each iterative training. In other words, Ĥ is constantly updated during each training. Therefore, during the iterative training of the prediction network, for the non-initial training (that is, non-first training) of the prediction network, H substituted into the formula (7) during the next iterative training may be Ĥ during the previous iterative training. In the formula (7), W₃ is a parameter matrix of the GAT, and b₃ is a bias vector. During the training of the prediction network, W₃ and b₃ are also constantly updated. In other words, W₃ and b₃ are network parameters of the prediction network.

It may be understood that, during each iteration of the prediction network, a different connecting edge may be removed based on the homogeneous object graph of the target object, to obtain a different first activation subgraph. It may be understood that, the next iterative training of the prediction network is performed based on a result of the previous iterative training.

Further, the computer device can generate the second object embedding feature of the target object based on the adjacency matrix [symbol] of the foregoing first activation subgraph. The process is shown in the following formula (8) to formula (10):

$${\hat{h}}_{i}^{( m + 1 )} = {‖}_{k = 1}^{K} σ ( {\sum }_{u ∈ {N}_{i}} {α}_{iu} {W}^{( m )} {\hat{h}}_{i}^{( m )} ) \qquad ( 8 )$$

$${α}_{iu} = \frac{exp ( LeakyRelu ( α [ W {\hat{h}}_{i}^{( m )} ‖ W {\hat{h}}_{u}^{( m )} ] ) )}{{\sum }_{v ∈ {N}_{i}} exp ( LeakyRelu ( α [ W {\hat{h}}_{i}^{( m )} ‖ W {\hat{h}}_{v}^{( m )} ] ) )} \qquad ( 9 )$$

$${\hat{h}}_{i} = σ ( \frac{1}{K} {\sum }_{k = 1}^{K} {\sum }_{u ∈ {N}_{i}} {α}_{iu} {W}^{( M )} {\hat{h}}_{i}^{( M - 1 )} ) . \qquad ( 10 )$$

Nᵢ represents a set of neighbor nodes of an i^{th} object feature node. The set of neighbor nodes of the i^{th} object feature node may be obtained through the adjacency matrix of the foregoing first activation subgraph. The neighbor nodes of the i^{th} object feature node are object feature nodes having connecting edges with the i^{th} object feature node in the first activation subgraph. u belongs to Nᵢ. In other words, u is a neighbor node of the i^{th} object feature node.

Through the foregoing formula (8) to formula (10), the object feature of the target object in the dimension indicated by each object feature node in the first activation subgraph can be propagated, thereby generating the node feature corresponding to each object feature node. Generation of a node feature ĥᵢ corresponding to the i^{th} object feature node is described in detail herein.

M feature generation network layers may exist in the GAT. A value of m may range from 0 to M−2. ĥᵢ^{(m)} represents an embedding feature of the i^{th} object feature node generated by an m^{th} feature generation network layer in the M feature generation network layers. ĥᵢ^{(m+1)} represents an embedding feature of the i^{th} object feature node generated by a next feature generation network layer of the m^{th} feature generation network layer in the M feature generation network layers. Each feature generation network layer can generate K embedding features of the i^{th} object feature node. A value of k ranges from 1 to K. For example, K ĥᵢ^{(m)} may be generated at the m^{th} layer. σ represents an activation function. In the formula (8), ∥ represents splicing, W^{(m)} represents a parameter matrix of the m^{th} feature generation network layer, and αᵢᵤ represents a normalized connecting edge weight between the i^{th} object feature node and a u^{th} object feature node.

For the formula (9), exp represents an exponential function, LeakyRelu and α represent activation functions (the two activation functions may be different), W represents a parameter matrix of the prediction network, which is a network parameter (that is, a model parameter), and is constantly updated during the training, and ∥ represents splicing. ĥᵤ^{(m)} represents an embedding feature of the u^{th} object feature node generated by the m^{th} feature generation network layer in the M feature generation network layers. ĥᵥ^{(m)} represents an embedding feature of a v^{th} object feature node generated by the m^{th} feature generation network layer in the M feature generation network layers. v also belongs to Nᵢ. In other words, v is a neighbor node of the i^{th} object feature node. v may be or may not be u. Through the formula (8) and the formula (9), embedding features of the i^{th} object feature node generated by first M−1 feature generation network layers of the foregoing M feature generation network layers (that is, when m is less than or equal to M−2) can be obtained. In other words, processing logic of the first M−1 feature generation network layers in the M feature generation network layers may be logic of the formula (8) and the formula (9). Processing logic of the last layer (that is, an M^{th} feature generation network layer) of the M feature generation network layers may be different from the processing logic of the first M−1 feature generation network layers. The processing logic of the M^{th} feature generation network layer may be processing logic of the formula (10). Through the M^{th} feature generation network layer, a final embedding feature of the i^{th} object feature node may be outputted as the node feature ĥᵢ of the i^{th} object feature node.

For the formula (10), W^{(M)} represents a parameter matrix of the M^{th} feature generation network layer, which is a network parameter, and needs to be constantly updated. ĥᵢ^{(M-1)} represents an embedding feature of the i^{th} object feature node generated by an (M−1)^{th} feature generation network layer (that is, when m is equal to M−2).

Through the foregoing process of obtaining the node feature of the i^{th} object feature node, the computer device can generate the node feature corresponding to each object feature node in the homogeneous object graph of the target object (that is, each object feature node in the first activation subgraph, the object feature nodes included in the first activation subgraph being the same as those in the homogeneous object graph of the target object being the same, but the connecting edges being different). The node features have the same dimension. For example, the node features may be feature vectors with 16 dimensions.

Further, the computer device can sum the node features corresponding to the object feature nodes of the target object to obtain the second object embedding feature of the target object. Summing the node features corresponding to the object feature nodes may mean summing element values at same positions in the node features respectively corresponding to the object feature nodes. Therefore, the obtained second object embedding feature of the target object has the same dimension as the node features.

For example, if the node features of the object feature nodes of the target object include a node feature (0.1, 0.2, 0.3) and a node feature (0.2, 0.4, 0.6), a result of summing the node feature (0.1, 0.2, 0.3) and the node feature (0.2, 0.4, 0.6) may be (0.3, 0.6, 0.9). In other words, the second object embedding feature of the target object is (0.3, 0.6, 0.9).

Further, the computer device can generate the second object embedding feature corresponding to each object in the manner of generating the second object embedding feature of the target object.

Step S203: Invoke the prediction network to generate a second resource embedding feature of each resource based on the homogeneous resource graph of each resource.

A process of generating the second resource embedding feature of each resource is the same as the foregoing process of generating the second object embedding feature of the target object. In this process, the homogeneous object graph of the target object needs to be replaced with the homogeneous resource graph of the resource and the object feature node needs to be replaced with the resource feature node. Therefore, for the specific process of generating the second resource embedding feature of each resource, reference may be made to the foregoing specific description in S202.

Before generating the second resource embedding feature of each resource, the computer device needs to input a resource label feature of each resource into the prediction network. The resource label feature of each resource may be obtained through a label feature of each resource. Dimensions of the resource label feature of each resource may be different. If a resource has label features in some dimensions, the resource label feature of the resource may have feature values corresponding to the label features in the dimensions. In this application, one label feature may correspond to a resource feature in one dimension. Therefore, a resource feature in one dimension may have only one feature value.

For example, if a resource has label features in 3 dimensions, a resource label feature of the resource may be composed of feature values corresponding to the label features in the 3 dimensions.

For example, a resource (such as a resource 1) is an animation, the resource 1 has label features in 3 dimensions, which are respectively a national custom feature, a fantasy feature, and a profile feature, and a feature value corresponding to the national custom feature is 0.1, a feature value corresponding to the fantasy feature is 0.2, and a feature value corresponding to the profile feature is 0.6. In this case, a resource label feature of the resource 1 may be (0.1, 0.2, 0.6). For another example, a resource (such as a resource 2) is a commodity advertisement, the resource 2 has label features in 4 dimensions, which are respectively a household feature, an appliance feature, an energy conservation feature, and a portability feature, and a feature value corresponding to the household feature is 0.11, a feature value corresponding to the appliance feature is 0.22, a feature value corresponding to the energy conservation feature is 0.33, and a feature value corresponding to the portability feature is 0.44. In this case, a resource label feature of the resource 2 may be (0.11, 0.22, 0.33, 0.44).

Similarly, each feature value (that is, a mapping value) in each dimension may be obtained by mapping the corresponding label feature into a uniform hash space. The label features in all dimensions may have a uniform hash space (which is different from the foregoing hash space of the object feature). By mapping the label features in all dimensions to the uniform hash space, it can be ensured that the label features (that is, resource features, one label feature correspondingly representing a resource feature in one dimension) in all dimensions are controllable. Moreover, it can be ensured that a new resource feature (for example, a resource feature in a dimension not used during training but used during actual prediction) is in a preset feature space (that is, the hash space). In other words, the prediction network can identify all resource features in the hash space corresponding to the resource features in all dimensions.

For example, for a specific style feature of a resource, the specific style feature of the resource may be mapped to the hash space through a specific hash algorithm (a specific expression of the algorithm may be determined based on an actual application scenario). For example, the specific style feature of the resource may have a feature identifier (id). In this case, a hash operation may be performed on the feature id to obtain a feature value corresponding to the specific style feature.

Similarly, the computer device can obtain an initialized embedding feature corresponding to each resource feature node of each resource through the feature value included in the resource label feature of the resource.

For example, any one of the M resources may be represented as a target resource. The computer device can invoke the GAT to perform connecting edge deletion processing on the homogeneous resource graph of the target resource to obtain an activation subgraph of the homogeneous resource graph of the target resource. The activation subgraph of the homogeneous resource graph of the target resource may be referred to as a second activation subgraph. A manner of obtaining the second activation subgraph is the same as the manner of obtaining the first activation subgraph.

Further, the computer device can perform feature propagation processing on resource features of the target resource in a plurality of dimensions based on the second activation subgraph, to obtain a node feature corresponding to each resource feature node of the target resource in the second activation subgraph (that is, each resource feature node in the homogeneous resource graph, the resource feature nodes in the homogeneous resource graph of the target resource being the same as the resource feature nodes in the second activation subgraph of the target resource, but connecting edges between the resource feature nodes being different). A process of obtaining the node feature corresponding to each resource feature node of the target resource is the same as the foregoing process of obtaining the node feature corresponding to each object feature node of the target object.

Therefore, the computer device can generate a second resource embedding feature of the target resource through the node feature corresponding to each resource feature node of the target resource. A process of generating the second resource embedding feature of the target resource based on the node feature corresponding to each resource feature node of the target resource is the same as the foregoing process of generating the second object embedding feature of the target object based on the node feature corresponding to each object feature node of the target object.

Through a process the same as the foregoing process of generating the second resource embedding feature of the target resource, the computer device can generate a second resource embedding feature of each resource. One resource corresponds to one second resource embedding feature.

Step S204: Train the prediction network based on the first object embedding feature of each object, the second object embedding feature of each object, the first resource embedding feature of each resource, and the second resource embedding feature of each resource, to obtain the trained prediction network.

The computer device can generate a predicted loss value of the prediction network through the first object embedding feature of each object, the second object embedding feature of each object, the first resource embedding feature of each resource, and the second resource embedding feature of each resource. The predicted loss value represents a prediction deviation of the prediction network for the object and the resource. A larger predicted loss value indicates a larger prediction deviation of the prediction network. On the contrary, a smaller predicted loss value indicates a smaller prediction deviation of the prediction network.

Therefore, the computer device can correct the network parameter (that is, a model parameter) of the prediction network through the predicted loss value. For example, the network parameter of the prediction network may be adjusted to minimize the predicted loss value.

The prediction network may be constantly iteratively trained, and each training has a corresponding predicted loss value. The network parameter of the corrected prediction network is constantly updated and corrected through the predicted loss value generated during each iterative training. A final trained prediction network (for example, a prediction network existing when the network parameter is trained to a converged state or a quantity of times of training reaches a quantity threshold) may be used as the trained prediction network.

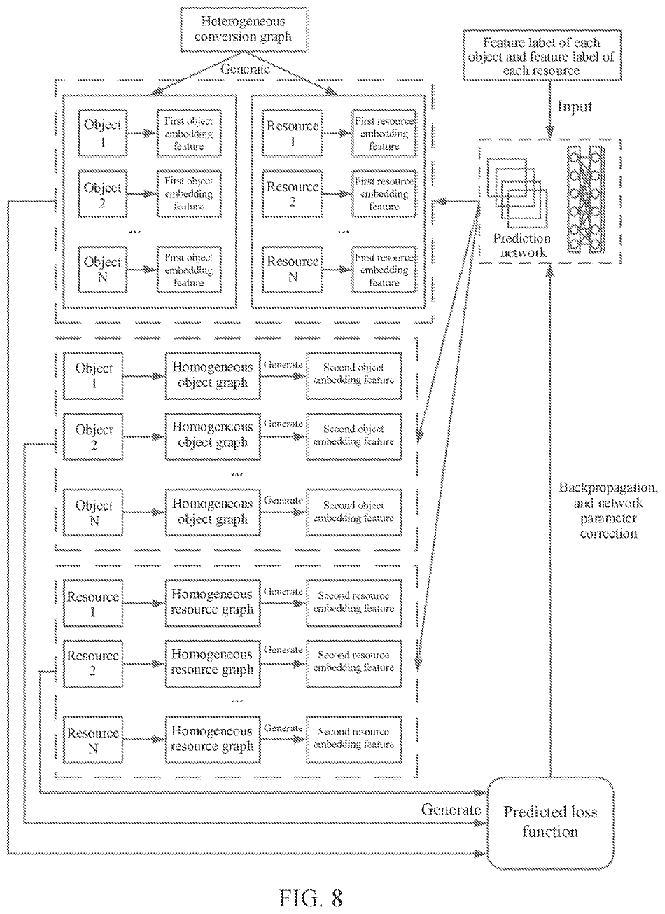

FIG. 8 is a schematic diagram of a scenario of network training according to this application. As shown in FIG. 8, the computer device can invoke the prediction network to generate the first object embedding feature of each object and the first resource embedding feature of each resource through the heterogeneous conversion graph. The computer device can further invoke the prediction network to generate the second object embedding feature of each object through the homogeneous object graph of each object. The computer device can further invoke the prediction network to generate the second resource embedding feature of each resource through the homogeneous resource graph of each resource.

Further, the computer device can generate a predicted loss function (that is, the foregoing predicted loss value) of the prediction network through the first object embedding feature of each object, the second object embedding feature of each object, the first resource embedding feature of each resource, and the second resource embedding feature of each resource that are generated. Therefore, the trained prediction network may be obtained by correcting the network parameter of the prediction network through the predicted loss function.

In this application, the embedding features (such as the second resource embedding feature and the second object embedding feature) obtained though the homogeneous graph (such as the homogeneous resource graph and the homogeneous object graph) are aligned with the embedding features (such as the first resource embedding feature and the first object embedding feature) obtained through the heterogeneous conversion graph in a self-supervised manner, so that the homogeneous graph can be effectively generalized to a heterogeneous bipartite graph (that is, the heterogeneous conversion graph) and replace a bipartite graph in a cold start scenario. In this way, a cold start problem of a conventional bipartite graph method (for example, a problem that a new node in the bipartite graph may be an isolated node) can be resolved. Therefore, the prediction network can effectively learn the node feature corresponding to each node (including the object node and the resource node) in the heterogeneous bipartite graph, and accurately predict the conversion index of the object for the resource subsequently.

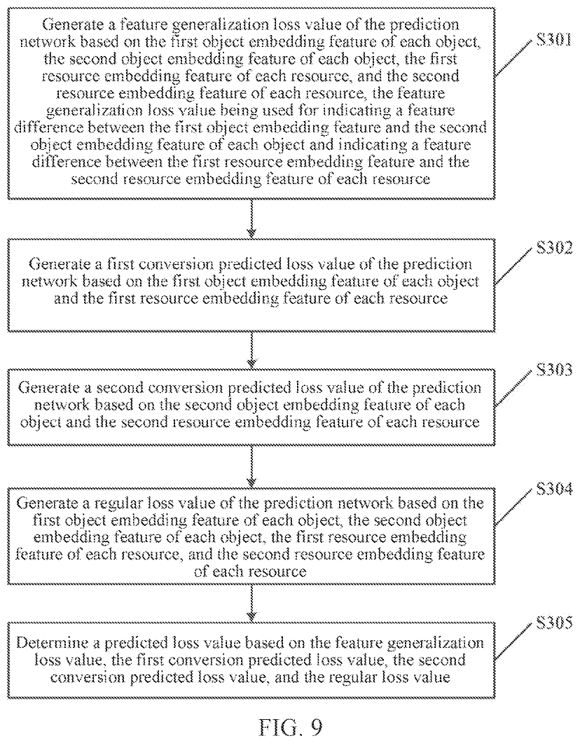

FIG. 9 is a schematic flowchart of a loss generation method according to this application. This embodiment of this application mainly describes how to generate a predicted loss value of the prediction network. An execution body in this embodiment of this application may be the same as the execution body in the embodiment corresponding to FIG. 3. As shown in FIG. 9, the method includes the following steps:

Step S301: Generate a feature generalization loss value of the prediction network based on the first object embedding feature of each object, the second object embedding feature of each object, the first resource embedding feature of each resource, and the second resource embedding feature of each resource, the feature generalization loss value being used for indicating a feature difference between the first object embedding feature and the second object embedding feature of each object and indicating a feature difference between the first resource embedding feature and the second resource embedding feature of each resource.

The computer device generalizes the feature space of the homogeneous graph to the feature space of the heterogeneous conversion graph. Specifically, the computer device can align the embedding features (including the second object embedding feature of each object and the second resource embedding feature of each resource) obtained through the homogeneous graph with the embedding features (including the first object embedding feature of each object and the first resource embedding feature of each resource) obtained through the heterogeneous conversion graph (even if the embedding features are similar), to generate the feature generalization loss value of the prediction network. The feature generalization loss value is used for representing a feature difference between the first object embedding feature and the second object embedding feature of each object and a feature difference between the first resource embedding feature and the second resource embedding feature of each resource.

For example, a larger feature generalization loss value indicates a larger feature difference between the first object embedding feature and the second object embedding feature of each object and a larger feature difference between the first resource embedding feature and the second resource embedding feature of each resource (that is, indicates being increasingly different). On the contrary, a smaller feature generalization loss value indicates a smaller feature difference between the first object embedding feature and the second object embedding feature of each object and a smaller feature difference between the first resource embedding feature and the second resource embedding feature of each resource (that is, indicates being increasingly similar).

The feature generalization loss value may be denoted as L_{S}. As shown in the following formula (11), the feature generalization loss value L_{S} is:

L_{S}=Σ_{aϵ[1,N],bϵ[1,M]}(∥eₐ−e′ₐ∥₁+∥e_{b}−e′_{b}∥₁) (11).

a represents an a^{th} object in the N objects, and a value of a ranges from 1 to N. Similarly, b represents a b^{th} resource in the M resources, and a value of b ranges from 1 to M. eₐ represents a first object embedding feature of the a^{th} object, e′ₐ represents a second object embedding feature of the a^{th} object, e_{b} represents a first resource embedding feature of the b^{th} resource, and en represents a second resource embedding feature of the b^{th} resource.

eₐ−e′ₐ represents a feature difference between the first object embedding feature and the second object embedding feature of the a^{th} object. Σ_{aϵ[1,N]}(∥eₐ−e′ₐ∥₁) may be referred to as a first generalization loss value, which represents a generalization loss value between the first object embedding feature and the second object embedding feature of the object. e_{b}−e′_{b} represents a feature difference between the first resource embedding feature and the second resource embedding feature of the b^{th} resource.

Σ_{bϵ[1,M]}(∥e_{b}−e′_{b}∥₁) may be referred to as a second generalization loss value, which represents a generalization loss value between the first resource embedding feature and the second resource embedding feature of the resource. The feature generalization loss value L_{S} is a sum of the first generalization loss value and the second generalization loss value. ∥ . . . ∥₁ represents a 1-norm.

Step S302: Generate a first conversion predicted loss value of the prediction network based on the first object embedding feature of each object and the first resource embedding feature of each resource.

The computer device can generate the first conversion predicted loss value of the prediction network based on the first object embedding feature of each object and the first resource embedding feature of each resource. The first conversion predicted loss value represents a predicted loss of predicting the conversion index of the object for the resource by the prediction network through the heterogeneous conversion graph.

First, a conversion index of the a^{th} object for the b^{th} resource predicted by the prediction network based on the heterogeneous conversion graph during the training may be denoted as [symbol] . The conversion index [symbol] may be referred to as a first predicted conversion index of the a^{th} object for the b^{th} resource. As shown in the following formula (12), the first predicted conversion index [symbol] of the a^{th} object for the b^{th} resource is:

[symbol]

=sigmoid(W₄[eₐ∥e_{b}]+b₄) (12).

sigmoid represents an activation function (which is an S function). W₄ represents a parameter matrix of the prediction network, which is a network parameter, and is constantly updated during the training. b₄ is a bias vector. eₐ represents the first object embedding feature of the a^{th} object. e_{b} represents the first resource embedding feature of the b^{th} resource. ∥ represents splicing.

Therefore, the first conversion predicted loss value may be denoted as L_{z1}. As shown in the following formula (13), the first conversion predicted loss value L_{z1} is:

L_{z1}=Σ_{aϵ[1,N],bϵ[1,M]}(−Y_{a,b}log [symbol] +(1−Y_{a,b})log(1− [symbol] )) (13).

Y_{a,b} represents a true conversion label between the a^{th} object and the b^{th} resource (which may be inputted during the training of the prediction network or obtained through the heterogeneous conversion graph). The conversion label indicates whether the a^{th} object has a conversion behavior for the b^{th} resource. [symbol] represents a conversion index of the a^{th} object for the b^{th} resource predicted through the heterogeneous conversion graph.

Step S303: Generate a second conversion predicted loss value of the prediction network based on the second object embedding feature of each object and the second resource embedding feature of each resource.

Similarly, the computer device can generate the second conversion predicted loss value of the prediction network based on the second object embedding feature of each object and the second resource embedding feature of each resource. The second conversion predicted loss value represents a predicted loss of predicting the conversion index of the object for the resource by the prediction network through the homogeneous graph (including the homogeneous object graph and the homogeneous resource graph).

First, the conversion index of the a^{th} object for the b^{th} resource predicted by the prediction network based on the homogeneous graph during the training may be denoted as [symbol] . The conversion index [symbol] may be referred to as a second predicted conversion index of the a^{th} object for the b^{th} resource. As shown in the following formula (14), the second predicted conversion index [symbol] of the a^{th} object for the b^{th} resource is:

[symbol]

=sigmoid(W₅[′ₐ∥e′_{b}]+b₅) (14).

sigmoid represents an activation function (which is an S function). W₅ represents a parameter matrix (which is usually different from the foregoing W₄) of the prediction network, which is a network parameter, and is constantly updated during the training. b₅ is a bias vector (which is usually different from the foregoing b₄). e′ₐ represents the second object embedding feature of the a^{th} object. e′_{b} represents the second resource embedding feature of the b^{th} resource. ∥ represents splicing.

Therefore, the second conversion predicted loss value may be denoted as L_{z2}. As shown in the following formula (15), the second conversion predicted loss value L_{z2} is:

L_{z2}=Σ_{aϵ[1,N],bϵ[1,M]}(−Y_{a,b}log [symbol] +(1−Y_{a,b})log(1− [symbol] )) (15).

Y_{a,b} represents a true conversion label between the a^{th} object and the b^{th} resource. The conversion label indicates whether the a^{th} object has a conversion behavior for the b^{th} resource. [symbol] represents a conversion index of the a^{th} object for the b^{th} resource predicted through the homogeneous graph.

It may be understood that, after the training of the prediction network is completed and the trained prediction network is obtained (the trained prediction network includes updated W₄ and updated b₄), the foregoing conversion index of the prediction object for the prediction resource may be generated through the principle shown in the foregoing formula (14). In this process, the second object embedding feature of the a^{th} object needs to be replaced with a second object embedding feature of the prediction object generated by the trained prediction network, and the second resource embedding feature of the b^{th} resource needs to be replaced with a second resource embedding feature of the prediction resource generated by the trained prediction network.

Step S304: Generate a regular loss value of the prediction network based on the first object embedding feature of each object, the second object embedding feature of each object, the first resource embedding feature of each resource, and the second resource embedding feature of each resource.

The computer device can further generate the regular loss value of the prediction network based on the first object embedding feature of each object, the second object embedding feature of each object, the first resource embedding feature of each resource, and the second resource embedding feature of each resource. The regular loss value is used for ensuring that the feature space obtained by learning the heterogeneous conversion graph and the homogeneous graph (such as the foregoing feature spaces in which the first object embedding feature, the second object embedding feature, the first resource embedding feature, and the second resource embedding feature are located) is on a surface of a unit spherical surface to avoid overfitting of the prediction network.

The regular loss value may be denoted as L_{R}. As shown in the following formula (16), the regular loss value L_{R} is:

$${L}_{R} = {\sum }_{a ∈ [ 1 , N ] , b ∈ [ 1 , M ]} ( \begin{matrix}{λ}_{1} {‖ {e}_{a} - 1 ‖}_{2} + {λ}_{2} {‖ {e}_{a}^{′} - 1 ‖}_{2} + \\ {λ}_{3} {‖ {e}_{b} - 1 ‖}_{2} + {λ}_{4} {‖ {e}_{b}^{′} - 1 ‖}_{2}\end{matrix} ) . \qquad ( 16 )$$

λ₁, λ₂, λ₃, and λ₄ are hyperparameters, which may be predefined, and ∥ . . . ∥₂ represents a 2-norm.

Step S305: Determine a predicted loss value based on the feature generalization loss value, the first conversion predicted loss value, the second conversion predicted loss value, and the regular loss value.

The computer device can generate (for example, through a weighted summation) a final predicted loss value of the prediction network by using the feature generalization loss value, the first conversion predicted loss value, the second conversion predicted loss value, and the regular loss value that are obtained.

The predicted loss value may be denoted as L. As shown in the following formula (17), the predicted loss value L is:

L=L_{z2}+αL_{S}+βL_{z1}+L_{R} (17).

L_{z2} is the foregoing generated second conversion predicted loss value, L_{S} is the foregoing feature generalization loss value, L_{z1} is the foregoing first conversion predicted loss value, and L_{R} is the foregoing regular loss value. α is a predefined hyperparameter for controlling a loss weight of L_{S}. β is a predefined hyperparameter for controlling a loss weight of L_{z1}. The foregoing L, L_{z2}, L_{S}, L_{z1}, and L_{R} are loss functions.

In this application, after the trained prediction network is obtained, the conversion index of the object for the resource may be predicted through the homogeneous graph of the object (such as the foregoing prediction object) and the resource (such as the foregoing prediction resource) based on the trained prediction network. Therefore, as shown in the formula (17), the second conversion predicted loss value L_{z2} is used as a main loss value in this application.

It may be understood that, in this application, the heterogeneous conversion graph of the object and the resource may be used only during the training of the prediction network. After the trained prediction network is obtained, the heterogeneous conversion graph of the object and the resource is no longer used. Instead, the homogeneous graphs of the object and the resource are used for predicting the conversion index of the object for the resource. For example, a second object embedding feature of an object needing prediction and a second resource embedding feature of a resource needing prediction are first generated from a homogeneous object graph of the object needing prediction and a homogeneous resource graph of the resource needing prediction through the foregoing process in the embodiment corresponding to FIG. 7, and then the conversion index of the object for the resource is generated through the second object embedding feature and the second resource embedding feature (as indicated by the foregoing formula (14)).

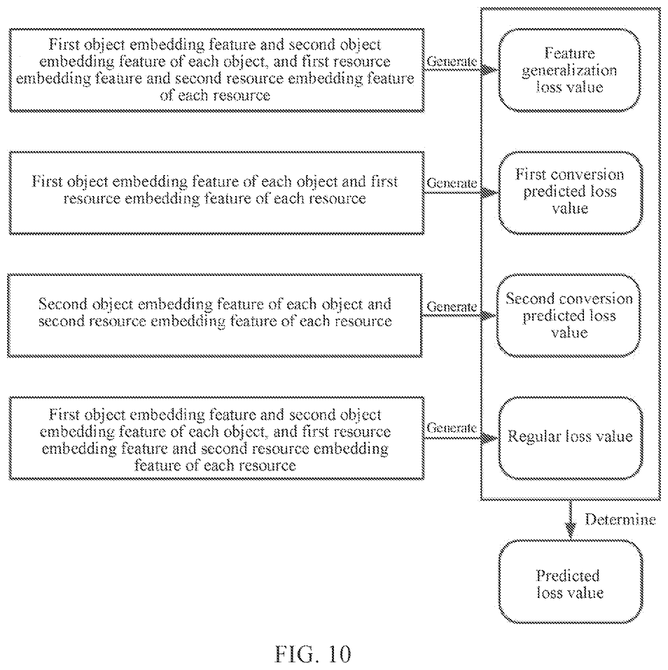

FIG. 10 is a schematic diagram of a scenario of generating a predicted loss value according to this application. As shown in FIG. 10, the computer device can generate the feature generalization loss value through the first object embedding feature and the second object embedding feature of each object and the first resource embedding feature and the second resource embedding feature of each resource. The computer device can further generate the first conversion predicted loss value through the first object embedding feature of each object and the first resource embedding feature of each resource. The computer device can further generate the second conversion predicted loss value through the second object embedding feature of each object and the second resource embedding feature of each resource. The computer device can further generate the regular loss value through the first object embedding feature and the second object embedding feature of each object and the first resource embedding feature and the second resource embedding feature of each resource.

Further, the computer device can generate the predicted loss value of the prediction network through the feature generalization loss value, the first conversion predicted loss value, the second conversion predicted loss value, and the regular loss value.

According to the method provided in this application, the predicted loss value of the prediction network is determined in combination with a plurality of loss values, which can improve training effect of the prediction network in various aspects. Through the foregoing feature generalization loss value L_{S}, the feature space of the homogeneous graph can be generalized to the feature space of the heterogeneous conversion graph in a self-supervised manner.

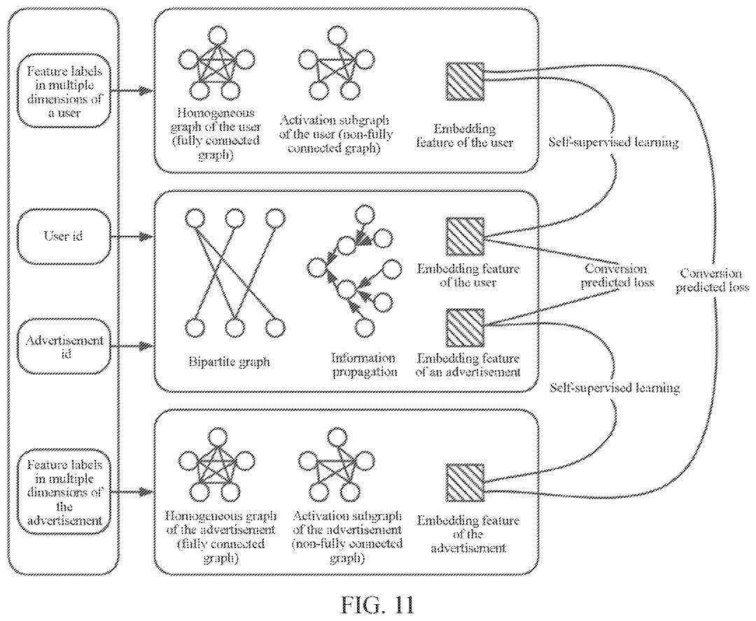

FIG. 11 is a schematic diagram of a scenario of model training according to this application. As shown in FIG. 11, in this application, a homogeneous graph of a user may be constructed by using feature labels in multiple dimensions of the user (which is used for indicating features in multiple dimensions of the user, that is, object features in multiple dimensions), and an activation subgraph (that is, the foregoing first activation subgraph) of the user may be obtained through a homogeneous graph of the user in the prediction network, and then an embedding feature (such as the foregoing second object embedding feature) of the user is obtained through the activation subgraph.

Similarly, in this application, a homogeneous graph of an advertisement may be constructed by using a feature labels in multiple dimensions of the advertisement (that is, the resource) (which is used for indicating advertisement features in multiple dimensions of the advertisement, that is, resource features in multiple dimensions), and an activation subgraph (that is, the foregoing second activation subgraph) of the advertisement may be obtained through the homogeneous graph of the advertisement in the prediction network, and then an embedding feature (such as the foregoing second resource embedding feature) of the advertisement is obtained through the activation subgraph.

In this application, a heterogeneous conversion graph between the user and the advertisement may be constructed. Then, information between nodes in the heterogeneous conversion graph may be transmitted (mapped to a corresponding hash space for transmission) through a user id (that is, the object id) and an advertisement id (that is, the resource id), to obtain the embedding feature (such as the foregoing first object embedding feature) of the user and the embedding feature (such as the foregoing first resource embedding feature) of the advertisement.

Further, the prediction network may perform self-supervised learning through the first object embedding feature of the user, the second object embedding feature of the user, the first resource embedding feature of the advertisement, and the second resource embedding feature of the advertisement (which may be reflected by the foregoing feature generalization loss values), and may perform learning for the conversion predicted loss through the first object embedding feature of the user, the second object embedding feature of the user, the first resource embedding feature of the advertisement, and the second resource embedding feature of the advertisement (which may be reflected by the first conversion predicted loss value and the second conversion predicted loss value), and may further perform learning for the regular loss (which may be reflected by the foregoing regular loss value), thereby obtaining a trained prediction network.

In a feasible implementation, this application may be applied in the field of game recommendation. The foregoing N objects may be N users. The M resources may be M game applications that may be recommended to the users. The conversion behavior of the object for the resource may be a behavior that a user registers with a game application.

Therefore, if a user registers a user account in a game application, the user has a conversion behavior for the game application, and a connecting edge exists between a node of the user (that is, the object node) and a node of the game application (that is, the resource node) in the heterogeneous conversion graph. On the contrary, if a user does not register a user account in a game application, the user has no conversion behavior for the game application, and no connecting edge exists between a node of the user and a node of the game application in the heterogeneous conversion graph.

In addition, in this application, a homogeneous graph of each user (that is, the homogeneous object graph) and a homogeneous graph of each game application (that is, the homogeneous resource graph) may be further obtained. Then, the prediction network is trained in combination with the heterogeneous conversion graph of the user and the game application, the homogeneous graph of the user, and the homogeneous graph of the game application, so as to obtain the trained prediction network. The trained prediction network can accurately predict a conversion index of any user for any game application.

In the field of game recommendation, the heterogeneous conversion graph applied for the user and the game application is combined with the homogeneous graph of the user and the homogeneous graph of the game application, a first condition, namely, the conversion behavior of the user for the game application is considered, and a second condition, namely, features of each user and each game application (which are reflected by the homogeneous graphs) are further fully considered. In this way, during the training of the prediction network, the prediction network can transfer, based on the two conditions the features obtained by learning, so that an accurate prediction network can be trained by training.

Therefore, through the method provided in this application, a cold start problem of a user in the field of game recommendation can be effectively resolved. For example, even if a new user having no conversion behavior for most or all of the M game applications exists (if the new user is a user in the N objects, a node of the new user is an isolated node in the heterogeneous conversion graph), a conversion index of the new user for each game application can still be accurately predicted through the prediction network obtained by training, and then accurate game application recommendation can be made to the new user based on the conversion index of the new user to each game application.

Moreover, in this application, during offline experiment, data of days 3-9 prior to a past date may be used as a training set, data of a day −2 is used as a validation set, and data of a day −1 is used as a test set. Training results of any 10 days are observed and extracted, and results of a multi-domain self-attention model are compared. An experimental result is shown in the following Table 1.

TABLE 1

| | Acc test (which is a | | AUC test (which is a | | GAUC test (which is a | |
|---|---|---|---|---|---|---|
| | classified evaluation | | model evaluation | | systematic evaluation | |
| | indicator) | | indicator) | | indicator) | |
| | Self- | | Self- | | Self- | |
| | supervised | | supervised | | supervised | |
| | graph (this | Multi- | graph (this | Multi- | graph (this | Multi- |
| Time | application) | domain | application) | domain | application) | domain |
| 2021 Dec. 23 | 0.7793 | 0.7769 | 0.8536 | 0.8577 | 0.7739 | 0.7817 |
| 2021 Dec. 24 | 0.7721 | 0.7662 | 0.8432 | 0.8338 | 0.7657 | 0.7456 |
| 2021 Dec. 25 | 0.8136 | 0.8171 | 0.8833 | 0.8837 | 0.7807 | 0.7805 |
| 2022 Jan. 1 | 0.6872 | 0.7407 | 0.8047 | 0.8423 | 0.7533 | 0.7645 |
| 2022 Jan. 2 | 0.7629 | 0.7579 | 0.8370 | 0.8335 | 0.7654 | 0.7554 |
| 2022 Jan. 3 | 0.7866 | 0.7765 | 0.8483 | 0.8431 | 0.7650 | 0.7551 |
| 2022 Jan. 11 | 0.7466 | 0.7388 | 0.8237 | 0.8369 | 0.7283 | 0.7241 |
| 2022 Jan. 12 | 0.7558 | 0.7528 | 0.8246 | 0.8240 | 0.7243 | 0.7226 |
| 2022 Jan. 13 | 0.7733 | 0.7907 | 0.7567 | 0.8166 | 0.6908 | 0.6781 |
| 2022 Jan. 14 | 0.8036 | 0.7954 | 0.8185 | 0.8081 | 0.6963 | 0.6890 |

The foregoing indicators under the self-supervised graph are indicators obtained by using the method provided in this application. It may be learned from the foregoing Table 1 that, compared with the multi-domain self-attention model, this application has improved the Acc, the AUC, and the AUCG that are tested in most cases.

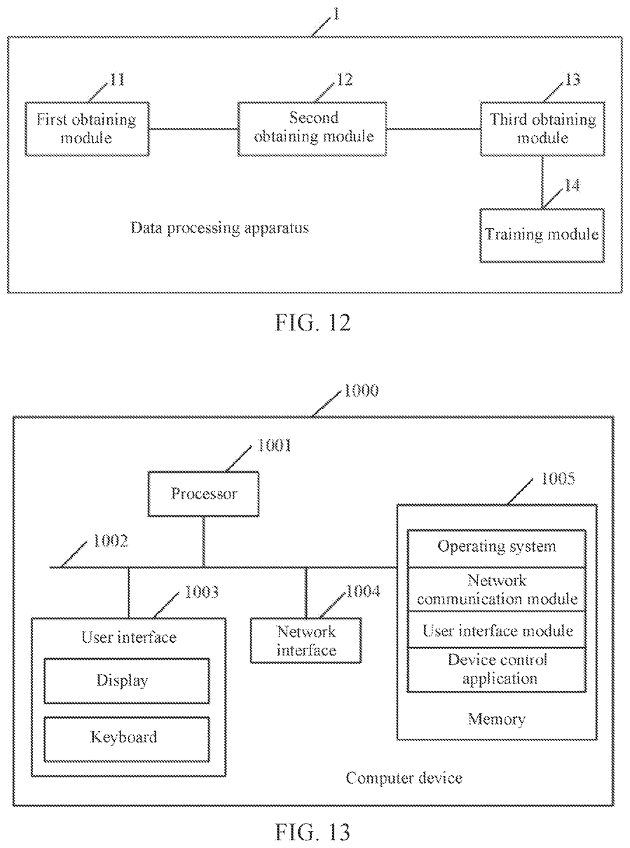

FIG. 12 is a schematic structural diagram of a data processing apparatus according to this application. The data processing apparatus may be a computer program (including program code) running in a computer device. For example, the data processing apparatus is application software. The data processing apparatus may be configured to perform the corresponding steps in the method provided in the embodiments of this application. As shown in FIG. 12, the data processing apparatus 1 may include a first obtaining module 11, a second obtaining module 12, a third obtaining module 13, and a training module 14.

The first obtaining module 11 is configured to obtain a heterogeneous conversion graph, the heterogeneous conversion graph including N object nodes and M resource nodes, each object node representing an object, each resource node representing a resource, N and M being positive integers, and when any one of the N objects has a conversion behavior for any one of the M resources, a connecting edge existing between the object node of any object and the resource node of any resource in the heterogeneous conversion graph.

The second obtaining module 12 is configured to obtain a homogeneous object graph corresponding to each of the N objects, any homogeneous object graph including a plurality of object feature nodes, any object feature node being configured to represent an object feature of a corresponding object in a dimension.

The third obtaining module 13 is configured to obtain a homogeneous resource graph corresponding to each of the M resources, any homogeneous resource graph including a plurality of resource feature nodes, any resource feature node being configured to represent a resource feature of a corresponding resource in a dimension.

The training module 14 is configured to train a prediction network based on the heterogeneous conversion graph, the homogeneous object graph of each object, and the homogeneous resource graph of each resource, to obtain a trained prediction network, the trained prediction network being configured to predict a conversion index of the object for the resource.

The training module 14 trains the prediction network based on the heterogeneous conversion graph, the homogeneous object graph of each object, and the homogeneous resource graph of each resource, to obtain the trained prediction network includes:

invoking the prediction network to generate a first object embedding feature of each object and a first resource embedding feature of each resource based on the heterogeneous conversion graph;

invoking the prediction network to generate a second object embedding feature of each object based on the homogeneous object graph of each object;

invoking the prediction network to generate a second resource embedding feature of each resource based on the homogeneous resource graph of each resource; and

training the prediction network based on the first object embedding feature of each object, the second object embedding feature of each object, the first resource embedding feature of each resource, and the second resource embedding feature of each resource, to obtain the trained prediction network.

The manner in which the training module 14 invokes the prediction network to generate the first object embedding feature of each object and the first resource embedding feature of each resource based on the heterogeneous conversion graph includes:

representing the heterogeneous conversion graph as a relationship matrix, the relationship matrix being configured to indicate a connecting edge relationship between the resource node and the object node in the heterogeneous conversion graph;

invoking the prediction network to obtain a feature propagation matrix, and propagating the object features of the N objects and the resource features of the M resources between the N objects and the M resources based on the feature propagation matrix and the relationship matrix, to generate an embedding feature matrix corresponding to the N objects and the M resources; and

generating the first object embedding feature of each object and the first resource embedding feature of each resource based on the embedding feature matrix.

A plurality of embedding feature matrices exist. The manner in which the training module 14 generates the first object embedding feature of each object and the first resource embedding feature of each resource based on the embedding feature matrix includes:

splicing the plurality of embedding feature matrix to obtain a spliced embedding feature matrix;

performing feature mapping processing on the spliced embedding feature matrix to obtain a target embedding feature matrix; and

extracting the first object embedding feature of each object and the first resource embedding feature of each resource from the target embedding feature matrix.

Any one of the N objects is represented as a target object, and a connecting edge exists between any two object feature nodes in the homogeneous object graph of the target object.

The manner in which the training module 14 invokes the prediction network to generate the second object embedding feature of each object based on the homogeneous object graph of each object includes:

invoking the prediction network to delete the connecting edge in the homogeneous object graph of the target object, to obtain a first activation subgraph of the homogeneous object graph of the target object;

performing feature propagation processing on object features of the target object in a plurality of dimensions based on the first activation subgraph, to obtain a node feature in the first activation subgraph corresponding to each object feature node of the target object; and

generating the second object embedding feature of the target object based on the node feature corresponding to each object feature node of the target object.

Any one of the M resources is represented as a target resource, and a connecting edge exists between any two resource feature nodes in the homogeneous resource graph of the target resource.

The manner in which the training module 14 invokes the prediction network to generate the second resource embedding feature of each resource based on the homogeneous resource graph of each resource includes:

invoking the prediction network to delete the connecting edge in the homogeneous resource graph of the target resource, to obtain a second activation subgraph of the homogeneous resource graph of the target resource;

performing feature propagation processing on resource features of the target resource in a plurality of dimensions based on the second activation subgraph, to obtain a node feature corresponding to each resource feature node of the target resource in the second activation subgraph; and

generating the second resource embedding feature of the target resource based on the node feature corresponding to each resource feature node of the target resource.

The manner in which the training module 14 trains the prediction network based on the first object embedding feature of each object, the second object embedding feature of each object, the first resource embedding feature of each resource, and the second resource embedding feature of each resource, to obtain the trained prediction network includes:

generating a predicted loss value of the prediction network based on the first object embedding feature of each object, the second object embedding feature of each object, the first resource embedding feature of each resource, and the second resource embedding feature of each resource; and

correcting a network parameter of the prediction network based on the predicted loss value, to obtain the trained prediction network.

The manner in which the training module 14 generates the predicted loss value of the prediction network based on the first object embedding feature of each object, the second object embedding feature of each object, the first resource embedding feature of each resource, and the second resource embedding feature of each resource includes:

generating a feature generalization loss value of the prediction network based on the first object embedding feature of each object, the second object embedding feature of each object, the first resource embedding feature of each resource, and the second resource embedding feature of each resource, the feature generalization loss value being used for indicating a feature difference between the first object embedding feature and the second object embedding feature of each object and indicating a feature difference between the first resource embedding feature and the second resource embedding feature of each resource;

generating a first conversion predicted loss value of the prediction network based on the first object embedding feature of each object and the first resource embedding feature of each resource;

generating a second conversion predicted loss value of the prediction network based on the second object embedding feature of each object and the second resource embedding feature of each resource;

generating a regular loss value of the prediction network based on the first object embedding feature of each object, the second object embedding feature of each object, the first resource embedding feature of each resource, and the second resource embedding feature of each resource; and

determining the predicted loss value based on the feature generalization loss value, the first conversion predicted loss value, the second conversion predicted loss value, and the regular loss value.

The manner in which the training module 14 generates the feature generalization loss value of the prediction network based on the first object embedding feature of each object, the second object embedding feature of each object, the first resource embedding feature of each resource, and the second resource embedding feature of each resource includes:

generating a first generalization loss value for an object embedding feature based on the first object embedding feature and the second object embedding feature of each object;

generating a second generalization loss value for a resource embedding feature based on the first resource embedding feature and the second resource embedding feature of each resource; and

generating the feature generalization loss value based on the first generalization loss value and the second generalization loss value.

The manner in which the training module 14 generates the first conversion predicted loss value of the prediction network based on the first object embedding feature of each object and the first resource embedding feature of each resource includes:

generating a first predicted conversion index of each object for each resource based on the first object embedding feature of each object and the first resource embedding feature of each resource; and

generating the first conversion predicted loss value based on the first predicted conversion index of each object for each resource and the conversion behavior of each object for each resource.

The manner in which the training module 14 generates the second conversion predicted loss value of the prediction network based on the second object embedding feature of each object and the second resource embedding feature of each resource includes:

generating a second predicted conversion index of each object for each resource based on the second object embedding feature of each object and the second resource embedding feature of each resource; and

generating the second conversion predicted loss value based on the second predicted conversion index of each object for each resource and the conversion behavior of each object for each resource.

The apparatus 1 is further configured to:

obtain a prediction object and a prediction resource;

invoke the trained prediction network to predict a conversion index of the prediction object for the prediction resource; and

push the prediction resource to the prediction object when the conversion index of the prediction object for the prediction resource is greater than or equal to a conversion index threshold.

According to an embodiment of this application, steps involved in the data processing method shown in FIG. 3 may be performed by each module in the data processing apparatus 1 shown in FIG. 12. For example, step S101 shown in FIG. 3 may be performed by the first obtaining module 11 shown in FIG. 12, step S102 shown in FIG. 3 may be performed by the second obtaining module 12 shown in FIG. 12, step S103 shown in FIG. 3 may be performed by the third obtaining module 13 shown in FIG. 12, and step S104 shown in FIG. 3 may be performed by the training module 14 shown in FIG. 12.

In this application, the heterogeneous conversion graph can be obtained, the heterogeneous conversion graph including the object nodes of the N objects and the resource nodes of the M objects, N and M being positive integers, and when any one of the N objects has a conversion behavior for any one of the M resources, a connecting edge existing between the object node of any object and the resource node of any resource in the heterogeneous conversion graph; the homogeneous object graph corresponding to each of the N objects can be obtained, any homogeneous object graph including a plurality of object feature nodes, any object feature node being configured to represent an object feature of a corresponding object in a dimension; the homogeneous resource graph corresponding to each of the M resources can be obtained, any homogeneous resource graph including a plurality of resource feature nodes, any resource feature node being configured to represent a resource feature of a corresponding resource in a dimension; the prediction network can be trained based on the heterogeneous conversion graph, the homogeneous object graph of each object, and the homogeneous resource graph of each resource, to obtain the trained prediction network; and the trained prediction network can be configured to predict the conversion index of the object for the resource. It may be learned that, according to the apparatus provided in this application, the prediction network can be trained in combination with the heterogeneous graph of the object and the resource, the homogeneous graph of the object, and the homogeneous graph of the resource, so that the features of each object and each resource (including both objects and resources between which no access behavior occurs and objects and resources between which an access behavior occurs) can be effectively propagated during the training of the prediction network. Therefore, accuracy of the trained prediction network can be improved, and the trained prediction network can accurately predict the conversion index of the object for the resource.

According to an embodiment of this application, the modules in the data processing apparatus 1 shown in FIG. 12 may be separately or all combined into one or a plurality of units, or one (or more) of the units herein may be further split into a plurality of small units by function, which can realize the same operations without affecting the implementation of the technical effects of the embodiments of this application. The foregoing modules are divided based on logical functions. In an actual application, a function of one module may be implemented by a plurality of units, or functions of a plurality of modules may be implemented by one unit. In another embodiment of this application, the data processing apparatus 1 may include another unit. In an actual application, these functions may be implemented with assistance of other units, and may be implemented with assistance of a plurality of units.

According to another embodiment of this application, a computer program (including program code) that can perform the steps involved in the corresponding method shown in FIG. 3 may be run in a general-purpose computer device such as a computer including processing elements such as a central processing unit (CPU), a random access storage medium (RAM), and a read-only storage medium (ROM) and storage elements, to construct the data processing apparatus 1 shown in FIG. 12, thereby implementing the data processing method in the embodiments of this application. The computer program may be recorded in, for example, a computer-readable storage medium, loaded into the foregoing computer device through the computer-readable storage medium, and run in the computing device.

FIG. 13 is a schematic structural diagram of a computer device according to this application. As shown in FIG. 13, a computer device 1000 may include a processor 1001, a network interface 1004, and a memory 1005. In addition, the computer device 1000 may further include a user interface 1003 and at least one communication bus 1002. The communication bus 1002 is configured to implement connection and communication between these components. The user interface 1003 may include a display and a keyboard. The user interface 1003 may further include a standard wired interface and a standard wireless interface. The network interface 1004 may include a standard wired interface and a standard wireless interface (such as a Wi-Fi interface). The memory 1005 may be a high-speed RAM memory, or may be a nonvolatile memory (non-transitory memory), such as at least one disk memory. The memory 1005 may alternatively be at least one storage apparatus located away from the processor 1001. As shown in FIG. 13, the memory 1005 used as a computer storage medium may include an operating system, a network communication module, a user interface module, and a device control application.

In the computer device 1000 shown in FIG. 13, the network interface 1004 can provide a network communication function. The user interface 1003 is mainly configured to provide an input interface for a user. The processor 1001 may be configured to invoke the device control application stored in the memory 1005, to implement the following operations:

obtaining a heterogeneous conversion graph, the heterogeneous conversion graph including N object nodes and M resource nodes, each object node representing an object, each resource node representing a resource, N and M being positive integers, and when any one of the N objects has a conversion behavior for any one of the M resources, a connecting edge existing between the object node of any object and the resource node of any resource in the heterogeneous conversion graph;

obtaining a homogeneous object graph corresponding to each of the N objects, any homogeneous object graph including a plurality of object feature nodes, any object feature node being configured to represent an object feature of a corresponding object in a dimension;

obtaining a homogeneous resource graph corresponding to each of the M resources, any homogeneous resource graph including a plurality of resource feature nodes, any resource feature node being configured to represent a resource feature of a corresponding resource in a dimension; and

training a prediction network based on the heterogeneous conversion graph,

the homogeneous object graph of each object, and the homogeneous resource graph of each resource, to obtain a trained prediction network, the trained prediction network being configured to predict a conversion index of the object for the resource.

It is to be understood that, the computer device 1000 described in this embodiment of this application can perform the foregoing description of the data processing method in the embodiment corresponding to FIG. 3, and can perform the foregoing description of the data processing apparatus 1 in the embodiment corresponding to FIG. 12. Details are not described herein. In addition, beneficial effects of using the same method are not described in detail herein.

Furthermore, this application further provides a computer-readable storage medium. The computer-readable storage medium has the computer program executed by the foregoing data processing apparatus 1 stored therein. The computer program includes program instructions. When executing the program instructions, the processor can perform the foregoing description of the data processing method in the embodiment corresponding to FIG. 3. Details are not described herein. For technical details not disclosed in the embodiment of the computer storage medium of this application, reference may be to the description of the method embodiment of this application.

In an example, the program instructions may be deployed on one computer device for execution, or deployed on a plurality of computer devices at one location for execution, or executed on a plurality of computer devices distributed at a plurality of locations and connected by a communication network. The plurality of computer devices distributed at the plurality of locations and connected by the communication network can form a blockchain network.

The computer-readable storage medium may be an internal storage unit in the data processing apparatus in any one of the foregoing embodiments or in the foregoing computer device, for example, a hard disk or an internal memory of the computer device. The computer-readable storage medium may alternatively be an external storage device of the computer device, for example, a plug-in hard disk, a smart media card (SMC), a secure digital (SD) card, or a flash card equipped on the computer device. Further, the computer-readable storage medium may alternatively include both the internal storage unit of the computer device and the external storage device. The computer-readable storage medium is configured to store the computer program and other programs and data required by the computer device. The computer-readable storage medium may be further configured to temporarily store data that has been outputted or that is to be outputted.

This application provides a computer program product or a computer program. The computer program product or the computer program includes computer instructions. The computer instructions are stored in a computer-readable storage medium. A processor of a computer device reads the computer instructions from the computer-readable storage medium, and the processor executes the computer instructions, so that the computer device performs the foregoing description of the data processing method in the embodiment corresponding to FIG. 3. Details are not described herein. For technical details not disclosed in the embodiment of the computer-readable storage medium involved in this application, reference may be made to the description of the method embodiment of this application.

The terms “first”, “second” and the like in the specification of the embodiments of this application, the claims, and the drawings are used for distinguishing between different objects, rather than being used for describing a specific order. In addition, the term “include” and any variant thereof are intended to cover non-exclusive inclusion. For example, processes, methods, apparatuses, products, or devices including a series of steps or modules are not limited to the listed steps or modules, but instead, include steps or modules not listed, or include other steps units inherent to these processes, methods, apparatuses, products, or devices.

A person of ordinary skill in the art may realize that steps of units and algorithms of various examples described with reference to the embodiments disclosed in this specification may be implemented by electronic hardware, computer software, or a combination of the electronic hardware and the computer software. To clearly describe the interchangeability of hardware and software, the compositions and steps of the various examples have been generally described in terms of functionality in the foregoing description. Whether the functions are performed by hardware or software depends on specific applications and design constraints of the technical solutions. A person skilled in the art may use different methods to implement the described functions for each particular application, but it is not to be considered that the implementation goes beyond the scope of this application.

The method and the related apparatus provided in the embodiments of this application are described with reference to the method flowcharts and/or schematic structural diagrams provided in the embodiments of this application. Specifically, each process and/or block in the method flowcharts and/or schematic structural diagrams and a combination of processes and/or blocks in the flowcharts and/or block diagrams may be implemented through computer program instructions. These computer program instructions may be provided to a processor of a general-purpose computer, a special-purpose computer, an embedded processing machine, or another programmable data processing device to generate a machine, so that instructions executed by the processor of the computer or the another programmable data processing device generate an apparatus for implementing functions specified in one or more processes of the flowcharts and/or one or more blocks of the schematic structural diagrams. These computer program instructions may alternatively be stored in a computer-readable memory that can direct the computer or the another programmable data processing device to operate in such a way that the instructions stored in the computer-readable memory generate an article of manufacture including an instruction apparatus which implements the functions specified in one or more processes of the flowcharts and/or one or more blocks of the schematic structural diagrams. These computer program instructions may alternatively be loaded onto the computer or the another programmable data processing device, so that a series of operations and steps are performed on the computer or the another programmable device, thereby generating computer-implemented processing. Therefore, the instructions executed on the computer or the another programmable device provide steps for implementing the specific functions in one or more processes in the flowcharts and/or in one or more blocks in the block diagrams.

The foregoing disclosure is merely exemplary embodiments of this application, and is not intended to limit the protection scope of this application. Therefore, equivalent variations made in accordance with the claims of this application fall within the scope of this application.

What is claimed is:

1. A data processing method performed by a computer device, the method comprising:
obtaining a heterogeneous conversion graph, the heterogeneous conversion graph comprising N object nodes and M resource nodes, each object node representing an object, each resource node representing a resource, N and M being positive integers, wherein a connecting edge between an object node and a resource node represents a conversion behavior from an object corresponding to the object node to a resource corresponding to the resource node;
obtaining a homogeneous object graph corresponding to each of the N objects, the homogeneous object graph comprising a plurality of object feature nodes, each object feature node being configured to represent an object feature of the corresponding object;
obtaining a homogeneous resource graph corresponding to each of the M resources, the homogeneous resource graph comprising a plurality of resource feature nodes, each resource feature node being configured to represent a resource feature of the corresponding resource; and
training a prediction network based on the heterogeneous conversion graph, the homogeneous object graph of each object, and the homogeneous resource graph of each resource, to obtain a trained prediction network, the trained prediction network being configured to predict a conversion index of an object of interest for a resource of interest.

2. The method according to claim 1, wherein the training a prediction network based on the heterogeneous conversion graph, the homogeneous object graph of each object, and the homogeneous resource graph of each resource, to obtain a trained prediction networks comprises:
invoking the prediction network to generate a first object embedding feature of each object and a first resource embedding feature of each resource based on the heterogeneous conversion graph;
invoking the prediction network to generate a second object embedding feature of each object based on the homogeneous object graph of the object;
invoking the prediction network to generate a second resource embedding feature of each resource based on the homogeneous resource graph of the resource; and
training the prediction network based on the first object embedding feature and the second object embedding feature of each object, the first resource embedding feature and the second resource embedding feature of each resource, to obtain the trained prediction network.

3. The method according to claim 2, wherein the invoking the prediction network to generate a first object embedding feature of each object and a first resource embedding feature of each resource based on the heterogeneous conversion graph comprises:
converting the heterogeneous conversion graph into a relationship matrix;
invoking the prediction network to obtain a feature propagation matrix for the heterogeneous conversion graph;
propagating the object features of the N objects and the resource features of the M resources between the N objects and the M resources based on the feature propagation matrix and the relationship matrix, to generate an embedding feature matrix corresponding to the N objects and the M resources; and
generating the first object embedding feature of each object and the first resource embedding feature of each resource based on the embedding feature matrix.

4. The method according to claim 2, wherein a connecting edge exists between any two object feature nodes in the homogeneous object graph of a target object of the N objects; and
the invoking the prediction network to generate a second object embedding feature of each object based on the homogeneous object graph of the object comprises:
invoking the prediction network to delete the connecting edge in the homogeneous object graph of the target object, to obtain a first activation subgraph of the homogeneous object graph of the target object;
performing feature propagation processing on object features of the target object in a plurality of dimensions based on the first activation subgraph, to obtain a node feature in the first activation subgraph corresponding to each object feature node of the target object; and
generating the second object embedding feature of the target object based on the node feature corresponding to each object feature node of the target object.

5. The method according to claim 2, wherein a connecting edge exists between any two resource feature nodes in the homogeneous resource graph of a target resource of the M resources; and
the invoking the prediction network to generate a second resource embedding feature of each resource based on the homogeneous resource graph of the resource comprises:
invoking the prediction network to delete the connecting edge in the homogeneous resource graph of the target resource, to obtain a second activation subgraph of the homogeneous resource graph of the target resource;
performing feature propagation processing on resource features of the target resource in a plurality of dimensions based on the second activation subgraph, to obtain a node feature corresponding to each resource feature node of the target resource in the second activation subgraph; and
generating the second resource embedding feature of the target resource based on the node feature corresponding to each resource feature node of the target resource.

6. The method according to claim 2, wherein the training the prediction network based on the first object embedding feature and the second object embedding feature of each object, the first resource embedding feature and the second resource embedding feature of each resource, to obtain the trained prediction network comprises:
generating a predicted loss value of the prediction network based on the first object embedding feature and the second object embedding feature of each object, the first resource embedding feature and the second resource embedding feature of each resource; and
correcting a network parameter of the prediction network based on the predicted loss value, to obtain the trained prediction network.

7. The method according to claim 1, wherein the method further comprises:
obtaining a prediction object and a prediction resource;
invoking the trained prediction network to predict a conversion index of the prediction object for the prediction resource; and
pushing the prediction resource to the prediction object when the conversion index of the prediction object for the prediction resource is greater than or equal to a conversion index threshold.

8. A computer device, comprising a memory and a processor, the memory having a computer program stored therein, the computer program, when executed by the processor, causing the computer device to perform a data processing method including:
obtaining a heterogeneous conversion graph, the heterogeneous conversion graph comprising N object nodes and M resource nodes, each object node representing an object, each resource node representing a resource, N and M being positive integers, wherein a connecting edge between an object node and a resource node represents a conversion behavior from an object corresponding to the object node to a resource corresponding to the resource node;
obtaining a homogeneous object graph corresponding to each of the N objects, the homogeneous object graph comprising a plurality of object feature nodes, each object feature node being configured to represent an object feature of the corresponding object;
obtaining a homogeneous resource graph corresponding to each of the M resources, the homogeneous resource graph comprising a plurality of resource feature nodes, each resource feature node being configured to represent a resource feature of the corresponding resource; and
training a prediction network based on the heterogeneous conversion graph, the homogeneous object graph of each object, and the homogeneous resource graph of each resource, to obtain a trained prediction network, the trained prediction network being configured to predict a conversion index of an object of interest for a resource of interest.

9. The computer device according to claim 8, wherein the training a prediction network based on the heterogeneous conversion graph, the homogeneous object graph of each object, and the homogeneous resource graph of each resource, to obtain a trained prediction networks comprises:
invoking the prediction network to generate a first object embedding feature of each object and a first resource embedding feature of each resource based on the heterogeneous conversion graph;
invoking the prediction network to generate a second object embedding feature of each object based on the homogeneous object graph of the object;
invoking the prediction network to generate a second resource embedding feature of each resource based on the homogeneous resource graph of the resource; and
training the prediction network based on the first object embedding feature and the second object embedding feature of each object, the first resource embedding feature and the second resource embedding feature of each resource, to obtain the trained prediction network.

10. The computer device according to claim 9, wherein the invoking the prediction network to generate a first object embedding feature of each object and a first resource embedding feature of each resource based on the heterogeneous conversion graph comprises:
converting the heterogeneous conversion graph into a relationship matrix;
invoking the prediction network to obtain a feature propagation matrix for the heterogeneous conversion graph;
propagating the object features of the N objects and the resource features of the M resources between the N objects and the M resources based on the feature propagation matrix and the relationship matrix, to generate an embedding feature matrix corresponding to the N objects and the M resources; and
generating the first object embedding feature of each object and the first resource embedding feature of each resource based on the embedding feature matrix.

11. The computer device according to claim 9, wherein a connecting edge exists between any two object feature nodes in the homogeneous object graph of a target object of the N objects; and
the invoking the prediction network to generate a second object embedding feature of each object based on the homogeneous object graph of the object comprises:
invoking the prediction network to delete the connecting edge in the homogeneous object graph of the target object, to obtain a first activation subgraph of the homogeneous object graph of the target object;
performing feature propagation processing on object features of the target object in a plurality of dimensions based on the first activation subgraph, to obtain a node feature in the first activation subgraph corresponding to each object feature node of the target object; and
generating the second object embedding feature of the target object based on the node feature corresponding to each object feature node of the target object.

12. The computer device according to claim 9, wherein a connecting edge exists between any two resource feature nodes in the homogeneous resource graph of a target resource of the M resources; and
the invoking the prediction network to generate a second resource embedding feature of each resource based on the homogeneous resource graph of the resource comprises:
invoking the prediction network to delete the connecting edge in the homogeneous resource graph of the target resource, to obtain a second activation subgraph of the homogeneous resource graph of the target resource;
performing feature propagation processing on resource features of the target resource in a plurality of dimensions based on the second activation subgraph, to obtain a node feature corresponding to each resource feature node of the target resource in the second activation subgraph; and
generating the second resource embedding feature of the target resource based on the node feature corresponding to each resource feature node of the target resource.

13. The computer device according to claim 9, wherein the training the prediction network based on the first object embedding feature and the second object embedding feature of each object, the first resource embedding feature and the second resource embedding feature of each resource, to obtain the trained prediction network comprises:
generating a predicted loss value of the prediction network based on the first object embedding feature and the second object embedding feature of each object, the first resource embedding feature and the second resource embedding feature of each resource; and
correcting a network parameter of the prediction network based on the predicted loss value, to obtain the trained prediction network.

14. The computer device according to claim 8, wherein the method further comprises:
obtaining a prediction object and a prediction resource;
invoking the trained prediction network to predict a conversion index of the prediction object for the prediction resource; and
pushing the prediction resource to the prediction object when the conversion index of the prediction object for the prediction resource is greater than or equal to a conversion index threshold.

15. A non-transitory computer-readable storage medium, having a computer program stored therein, the computer program being adapted to be loaded by a processor of a computer device and causing the computer device to perform a data processing method including:
obtaining a heterogeneous conversion graph, the heterogeneous conversion graph comprising N object nodes and M resource nodes, each object node representing an object, each resource node representing a resource, N and M being positive integers, wherein a connecting edge between an object node and a resource node represents a conversion behavior from an object corresponding to the object node to a resource corresponding to the resource node;
obtaining a homogeneous object graph corresponding to each of the N objects, the homogeneous object graph comprising a plurality of object feature nodes, each object feature node being configured to represent an object feature of the corresponding object;
obtaining a homogeneous resource graph corresponding to each of the M resources, the homogeneous resource graph comprising a plurality of resource feature nodes, each resource feature node being configured to represent a resource feature of the corresponding resource; and
training a prediction network based on the heterogeneous conversion graph, the homogeneous object graph of each object, and the homogeneous resource graph of each resource, to obtain a trained prediction network, the trained prediction network being configured to predict a conversion index of an object of interest for a resource of interest.

16. The non-transitory computer-readable storage medium according to claim 15, wherein the training a prediction network based on the heterogeneous conversion graph, the homogeneous object graph of each object, and the homogeneous resource graph of each resource, to obtain a trained prediction networks comprises:
invoking the prediction network to generate a first object embedding feature of each object and a first resource embedding feature of each resource based on the heterogeneous conversion graph;
invoking the prediction network to generate a second object embedding feature of each object based on the homogeneous object graph of the object;
invoking the prediction network to generate a second resource embedding feature of each resource based on the homogeneous resource graph of the resource; and
training the prediction network based on the first object embedding feature and the second object embedding feature of each object, the first resource embedding feature and the second resource embedding feature of each resource, to obtain the trained prediction network.

17. The non-transitory computer-readable storage medium according to claim 16, wherein a connecting edge exists between any two object feature nodes in the homogeneous object graph of a target object of the N objects; and
the invoking the prediction network to generate a second object embedding feature of each object based on the homogeneous object graph of the object comprises:
invoking the prediction network to delete the connecting edge in the homogeneous object graph of the target object, to obtain a first activation subgraph of the homogeneous object graph of the target object;
performing feature propagation processing on object features of the target object in a plurality of dimensions based on the first activation subgraph, to obtain a node feature in the first activation subgraph corresponding to each object feature node of the target object; and
generating the second object embedding feature of the target object based on the node feature corresponding to each object feature node of the target object.

18. The non-transitory computer-readable storage medium according to claim 16, wherein a connecting edge exists between any two resource feature nodes in the homogeneous resource graph of a target resource of the M resources; and
the invoking the prediction network to generate a second resource embedding feature of each resource based on the homogeneous resource graph of the resource comprises:
invoking the prediction network to delete the connecting edge in the homogeneous resource graph of the target resource, to obtain a second activation subgraph of the homogeneous resource graph of the target resource;
performing feature propagation processing on resource features of the target resource in a plurality of dimensions based on the second activation subgraph, to obtain a node feature corresponding to each resource feature node of the target resource in the second activation subgraph; and
generating the second resource embedding feature of the target resource based on the node feature corresponding to each resource feature node of the target resource.

19. The non-transitory computer-readable storage medium according to claim 16, wherein the training the prediction network based on the first object embedding feature and the second object embedding feature of each object, the first resource embedding feature and the second resource embedding feature of each resource, to obtain the trained prediction network comprises:
generating a predicted loss value of the prediction network based on the first object embedding feature and the second object embedding feature of each object, the first resource embedding feature and the second resource embedding feature of each resource; and
correcting a network parameter of the prediction network based on the predicted loss value, to obtain the trained prediction network.

20. The non-transitory computer-readable storage medium according to claim 15, wherein the method further comprises:
obtaining a prediction object and a prediction resource;
invoking the trained prediction network to predict a conversion index of the prediction object for the prediction resource; and
pushing the prediction resource to the prediction object when the conversion index of the prediction object for the prediction resource is greater than or equal to a conversion index threshold.
